(19) United States
(12) Patent Application Publication
(10) Pub. No.: US 2023/0291562 A1
(43) Pub. Date: Sep. 14, 2023

(54) APPARATUS AND METHOD OF MANAGING NON-FUNGIBLE TOKENS BASED ON BLOCKCHAIN

(71) Applicant: Dunamu Inc., Seoul (KR)

(72) Inventor: Jihoon LIM, Seoul (KR)

(73) Assignee: Dunamu Inc., Seoul (KR)

(21) Appl. No.: 18/178,908

(22) Filed: Mar. 6, 2023

(30) Foreign Application Priority Data
Mar. 8, 2022 (KR) 10-2022-0029302
Jul. 29, 2022 (KR) 10-2022-0095024
Sep. 7, 2022 (KR) 10-2022-0113374

(51) Int. Cl. H04L 9/32; H04L 9/00

(52) U.S. Cl. CPC H04L 9/3213; H04L 9/50

(57) ABSTRACT

An electronic apparatus includes a communication interface configured to communicate with one or more nodes of a blockchain network and an external device; one or more memories configured to store one or more instructions; and one or more processors configured to execute the one or more instructions to: receive a registration request for a token for a date from the external device; register the token to correspond to the date based on the registration request; and transmit posting information associated with the date to the external device, wherein the posting information includes a display attribute of an entry corresponding to the token, wherein the registration request includes date indication information indicating the date, and token identification information identifying the token.

### CROSS-REFERENCE TO RELATED APPLICATIONS

This application is based on and claims priority under 35 U.S.C. § 119 to Korean Patent Application No. 10-2022-0029302, filed on Mar. 8, 2022, Korean Patent Application No. 10-2022-0095024, filed on Jul. 29, 2022 and Korean Patent Application No. 10-2022-0113376, filed on Sep. 7, 2022, in the Korean Intellectual Property Office, the disclosures of which are incorporated by reference herein in their entireties.

### BACKGROUND

### 1. Field

The disclosure relates to a technique for managing non-fungible tokens based on a blockchain.

### 2. Description of Related Art

Recently, in addition to idols and actors, various types of entertainers or celebrities such as influencers and YouTubers are appearing in various media. In the entertainment business related to such entertainers or celebrities, fans of a specific entertainer are increasingly recording their favorite entertainer's schedule or promoting the entertainer to others.

In addition, fans may also increasingly promote an entertainer to others by posting the entertainer's photos directly in areas exposed to an unspecified large number of people, for example advertisement panels or outdoor billboards at subway platforms or bus stops.

### SUMMARY

Provided is a technique for preventing one area for a specific date on a calendar screen displayed in a user terminal from being excessively filled with a specific object corresponding to a token.

Also provided is a technique for preventing a user who purchases a token that can be registered to correspond to one specific date from registering the token on a plurality of specific dates.

Also provided is a technique for allowing a user to easily understand history information about a specific object.

Also provided is a technique for allowing a user who has registered a token to correspond to a specific date to arbitrarily change the registered token to another token.

Additional aspects will be set forth in part in the description which follows and, in part, will be apparent from the description, or may be learned by practice of the presented embodiments.

In accordance with an aspect to the disclosure, an electronic apparatus includes a communication interface configured to communicate with one or more nodes of a blockchain network and an external device; one or more memories configured to store one or more instructions; and one or more processors configured to execute the one or more instructions to: receive a registration request for a token for a date from the external device; register the token to correspond to the date based on the registration request, and wherein the registration request includes date indication information indicating the date, and token identification information identifying the token; and transmit posting information associated with the date to the external device, wherein the posting information includes a display attribute of an entry corresponding to the token.

A display attribute of an image corresponding to the token may be determined based on the date indication information.

The display attribute may include at least one from among a display priority of the image, a display position of the image, and a display size of the image.

The display attribute may be determined based on the date indication information, and may include at least one from among a display priority of the entry, a display position of the entry, and a display size of the entry

The one or more processors may be further configured to register the token with the blockchain network by transmitting the date indication information and the token identification information to the one or more nodes of the blockchain network.

The token may include a first date attribute group including one or more date attributes, and the one or more processors may be further configured to: acquire the first date attribute group from the one or more nodes of the blockchain network; determine whether the date indicated by the date indication information matches a date attribute of the one or more date attributes; and transmit the date indication information and the token identification information to the one or more nodes of the blockchain network according to a determination that the date matches the date attribute of the one or more date attributes.

The one or more memories may be further configured to store a first date attribute group including one or more date attributes corresponding to the token, and the one or more processors may be further configured to: acquire the first date attribute group from the one or more memories; determine whether the date indicated by the date indication information matches a date attribute of the one or more date attributes; and transmit the date indication information and the token identification information to the one or more nodes of the blockchain network according to a determination that the date matches the date attribute of the one or more date attributes.

The one or more processors may be further configured to: receive a replacement request for replacing the token registered to correspond to the date with a replacement token from the external device; and based on the replacement request, deregister the token and register the replacement token to correspond to the date, and the replacement request may include information about the token and information about the replacement token.

The one or more processors may be further configured to deregister the token based on a lock-up release condition for the token being satisfied, and the lock-up release condition may be satisfied based on a predetermined period elapsing from a start of a registration time of the token.

The token may include information for accessing an image.

The one or more processors may be further configured to: receive a transmission request for posting information about the date from the external device; generate token list information about a plurality of tokens registered to correspond to the date; generate the posting information based on the token list information; and transmit the posting information to the external device, and wherein the posting information may include information about each token of the plurality of tokens.

The one or more processors may be further configured to: receive information about one or more tokens from among the plurality of tokens registered to correspond to the date from the one or more nodes of the blockchain network; and generate the token list information based on the information about the one or more tokens.

The posting information may include a posting priority corresponding to the plurality of tokens, and the one or more processors may be further configured to determine the posting priority based on a registration request reception time of the each token of the plurality of tokens.

The token list information may include token group information indicating one or more token groups to which the plurality of tokens respectively belong, the posting information may include a posting priority corresponding to the plurality of tokens, and the one or more processors may be further configured to determine the posting priority based on the token group information.

The one or more processors may be further configured to determine the posting priority based on a number of tokens belonging to each token group of the one or more token groups.

The token may include a first token including a first date attribute group including at least one first date attribute, the one or more processors may be further configured to: generate a second date attribute group including at least one second date attribute, wherein the at least one second date attribute is different from the at least one first date attribute; and transmit a generation request for a second token to the one or more nodes of the blockchain network, and the generation request for the second token includes information about the first token and information about the second date attribute group.

The one or more processors may be further configured to: receive information indicating an object from the external device; identify one or more tokens which are associated with the object and registered to correspond to one or more registration dates; generate history information for the object based on information about each of the identified one or more tokens; and transmit the history information to the external device.

In accordance with an aspect to the disclosure, a method performed by an electronic apparatus including one or more processors, includes: receiving a registration request for a token for a date from an external device; registering the token to correspond to the date based on the registration request; and transmitting posting information associated with the date to the external device, wherein the posting information includes a display attribute of an entry corresponding to the token, wherein the registration request includes date indication information indicating the date and token identification information identifying the token.

The display attribute may be determined based on the date indication information, and may include at least one from among a display priority of the entry, a display position of the entry, and a display size of the entry.

The registering of the token may further include transmitting the date indication information and the token identification information to one or more nodes of a blockchain network.

The method may further include receiving a transmission request for posting information for the date from the external device; generating token list information about a plurality of tokens registered to correspond to the date; generating the posting information based on the token list information; and transmitting the posting information to the external device, wherein the posting information includes information about each token of the plurality of tokens.

In accordance with an aspect to the disclosure, a method performed by an electronic apparatus including one or more processors, includes transmitting a registration request for a token for a date to an external device; receiving approval information corresponding to the registration request from the external device based on the registration request and information stored in one or more nodes of a blockchain network; receiving posting information associated with the date from the external device, wherein the posting information includes a display attribute of an entry corresponding to the token; and displaying the entry on a display of the electronic apparatus according to the display attribute, wherein the registration request includes date indication information indicating the date and token identification information identifying the token.

The display attribute may be determined based on the date indication information, and may include at least one from among a display priority of the entry, a display position of the entry, and a display size of the entry.

The method may further include transmitting a transmission request for posting information for the date to the external device; and receiving the posting information from the external device based on the transmission request, wherein the posting information is generated based on token list information about a plurality of tokens registered to correspond to the date, and includes information about each token of the plurality of tokens.

In accordance with an aspect to the disclosure, an electronic apparatus includes a communication interface configured to communicate with one or more nodes of a blockchain network and an external device; one or more memories configured to store one or more instructions; and one or more processors configured to execute the instructions to: receive a registration request for a first token associated with an object from the external device; register the first token to be locked-up for a period of time based on the registration request; determine a second token to be owned by an owner of the first token based on information about the first token; and transmit information about the second token to the owner of the first token.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a view showing a system including a server, a user terminal, a blockchain network, and a communication network, according to an embodiment.

FIG. 2 is a block diagram of a server according to one embodiment.

FIG. 3 is a block diagram of a user terminal according to an embodiment.

FIG. 4 is a conceptual diagram of a blockchain network according to an embodiment.

FIG. 5 is a flowchart showing operations of a server that processes a registration request for a specific token for a specific date received from a user terminal according to an embodiment.

FIG. 6 is a flowchart for explaining a method for a server to process a registration request for a specific token for a specific date received from a user terminal according to another embodiment.

FIG. 7 is a flowchart showing operations of a server that processes a registration request for a specific token for a specific person received from a user terminal according to still another embodiment.

FIG. 8 is a flowchart showing operations of a server that processes a transmission request of posting information received from a user terminal according to an embodiment.

FIG. 9A is an exemplary view showing a screen that can be displayed when posting information is displayed through an output unit of a user terminal according to an embodiment.

FIG. 9B is an exemplary view showing a screen that can be displayed when posting information is displayed through an output unit of a user terminal according to another embodiment.

FIG. 9C is an exemplary view showing a screen that can be displayed when posting information is displayed through an output unit of a user terminal according to still another embodiment.

FIG. 9D is an exemplary view showing a screen that can be displayed when posting information is displayed through an output unit of a user terminal according to yet another embodiment.

FIG. 10 is a flowchart showing operations of a server that processes information indicating a specific object received from a user terminal according to an embodiment.

FIG. 11 is a flowchart showing operations of a server that processes a replacement request received from a user terminal according to an embodiment.

FIG. 12 is a flowchart for explaining a method of processing a replacement request of a user terminal according to another embodiment.

### DETAILED DESCRIPTION

Various embodiments are described below as examples for the purpose of clearly explaining technical ideas of the present disclosure, and are not intended to be limiting. Technical ideas of the present disclosure include various modifications, equivalents, and alternatives of individual embodiments described in the present disclosure, and embodiments selectively combined from all or part of individual embodiments. In addition, the scope of the rights of the technical ideas of the present disclosure is not limited to the various embodiments presented below or specific descriptions thereof.

All technical or scientific terms used herein may have meanings that are generally understood by a person having ordinary knowledge in the art to which the present disclosure pertains, unless otherwise specified.

The expressions “include,” “can include,” “provided with,” “may be provided with,” “have,” “may have,” and the like used herein mean that features (for example, functions, operations, components, etc.) to be the objects exist, and do not exclude the existence of other additional features. That is, such expressions should be understood as open-ended terms connoting the possibility of inclusion of other embodiments.

A singular expression used herein can include meanings of plurality, unless otherwise mentioned, and the same is applied to a singular expression stated in the claims.

The terms “first,” “second,” etc. used herein are used to identify a plurality of components from one another, unless otherwise mentioned, and are not intended to limit the order or importance of the relevant components. For example, individual users included in a plurality of users according to the present disclosure may be distinguished from each other by being expressed as, for example, a “first user” and a “second user.” In addition, a plurality of tokens according to the present disclosure may be distinguished from each other by being expressed as, for example, a “first token” and a “second token.” In addition, one or more date attribute groups according to the present disclosure may be distinguished from each other by being expressed as a “first date attribute group” and a “second date attribute group.

The expressions “A, B, and C,” “A, B, or C,” “at least one of A, B, and C,” or “at least one of A, B, or C” used herein, may refer to each of listed items or all possible combinations of listed items. For example, “at least one of A or B” may refer to all of (1) at least one A, (2) at least one B, and (3) at least one A and at least one B.

The term “unit” used herein may refer to a software component or hardware component, such as a field-programmable gate array (FPGA) and an application specific integrated circuit (ASIC). However, the “unit” is not limited to software and hardware, and it may be configured to be an addressable storage medium or may be configured to run on one or more processors. In embodiments, the “unit” may include components, such as software components, object-oriented software components, class components, and task components, as well as processors, functions, attributes, procedures, subroutines, segments of program codes, drivers, firmware, micro-codes, circuits, data, databases, data structures, tables, arrays, and variables.

The expression “based on” used herein is used to describe one or more factors that influence a decision, an action of judgment, or an operation described in a phrase or sentence including the relevant expression, and this expression does not exclude additional factors influencing the decision, the action of judgment, or the operation.

When a certain component (for example, a first component) is described as “coupled to” or “connected to” another component (for example, a second component), this should be understood as meaning that the certain component may be coupled or connected directly to the another component and that the certain component may be coupled or connected to the another component via a new intervening component (for example, a third component).

The expression “configured to” used herein may mean “set to,” “have the ability to,” “changed to,” “made to,” “capable of doing,” etc., depending on the contexts. The expression is not limited in the sense of “specially designed in hardware.” For example, a processor configured to perform a particular operation may refer to a generic purpose processor capable of performing that particular operation by executing software, or it may refer to a special purpose computer structured through programming to perform the relevant particular operation.

Hereinafter, various embodiments of the present disclosure will be described with reference to the accompanying drawings. Throughout the following description and the accompanying drawings, like or substantially equivalent components are denoted by like reference numerals. In the following description of various embodiments, repeated descriptions of identical or corresponding components may be omitted for convenience. However, even if a description of a component is omitted, such a component is not intended to be excluded from an embodiment.

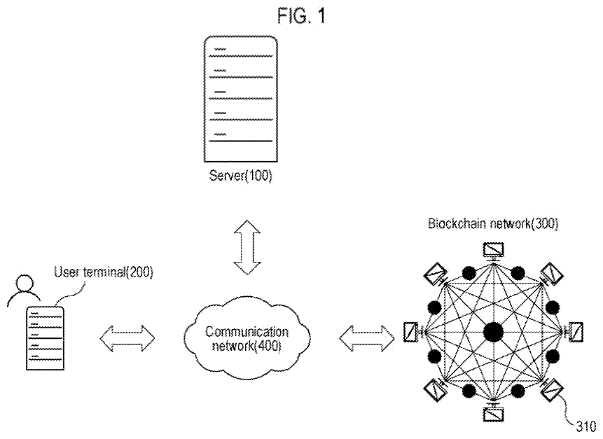

FIG. 1 is a view showing a system including a server 100, a user terminal 200, a blockchain network 300, and a communication network 400 according to embodiments of the present disclosure. The server 100, the user terminal 200, and at least one node 310 included in the blockchain network 300 can exchange information with each other through the communication network 400 according to a non-fungible token management technique disclosed herein. In the present disclosure, a calendar may be displayed in a relevant device by software or an application running in the server 100, the user terminal 200, or other electronic apparatuses. The calendar may include information about at least one date.

The server 100 may be an electronic apparatus of a service provider. The service provider may be an operating entity of a service that provides the calendar according to the non-fungible token management technique disclosed herein. The server 100, which may be an electronic apparatus that transmits information or provides a service to the user terminal 200 connected by wire or wirelessly, may be, for example, an application server, a proxy server, a cloud server, or the like.

The user terminal 200 may be a terminal of a user who uses the aforementioned calendar providing service. The user terminal 200 may be at least one of, for example, a smartphone, a tablet computer, a personal computer (PC), a mobile phone, a personal digital assistant (PDA), an audio player, and a wearable device.

When describing the configuration or operation of a device in the present disclosure, the term “device” may refer to a device that is the object of description, and the term “external device” may refer to a device that exists externally from the viewpoint of the device which is the object of description. For example, when the server 100 is described as a “device,” the user terminal 200 may be referred to as an “external device” from the viewpoint of the server 100. In addition, for example, when the user terminal 200 is described as a “device,” the server 100 may be referred to as an “external device” from the viewpoint of the user terminal 200. That is, the server 100 and the user terminal 200 may be referred to as a “device” and an “external device,” respectively, or an “external device” and a “device,” respectively, depending on the viewpoint of the operating entity.

The blockchain network 300 may include at least one node 310 that manages the blockchain. The at least one node included in the blockchain network 300 may be an independent electronic device capable of processing calculations which may be used to manage or operate the blockchain. At least some operations of the non-fungible token management technique disclosed herein may be performed by a smart contract recorded in the blockchain. To this end, the server 100 or the user terminal 200 may exchange information with at least one node included in the blockchain network 300.

The communication network 400 may include both a wired communication network and a wireless communication network. The communication network 400 may allow data to be exchanged between at least two of the server 100, the user terminal 200, and the blockchain network 300. The wired communication network may include, for example, a communication network configured to allow communication according to various protocols or standards such as Universal Serial Bus (USB), High Definition Multimedia Interface (HDMI), Recommended Standard-232 (RS-232, or Plain Old Telephone Service (POTS). The wireless communication network may include, for example, a communication network configured to allow communication according to various protocols or standards such as enhanced Mobile Broadband (eMBB), Ultra Reliable Low-Latency Communications (URLLC), Massive Machine Type Communications (MMTC), Long-Term Evolution (LTE), LTE Advance (LTE-A), New Radio (NR), Universal Mobile Telecommunications System (UMTS), Global System for Mobile communications (UMTS), Code Division Multiple Access (CDMA), Wideband CDMA (WCDMA), Wireless Broadband (WiBro), Wireless Fidelity (WiFi), Bluetooth, Near Field Communication (NFC), Global Positioning System (GPS), or Global Navigation Satellite System (GNSS). The communication network 400 of the present disclosure is not limited to the above-mentioned examples, and may include, without limitation, various types of communication networks that allow data to be exchanged between a plurality of entities or devices.

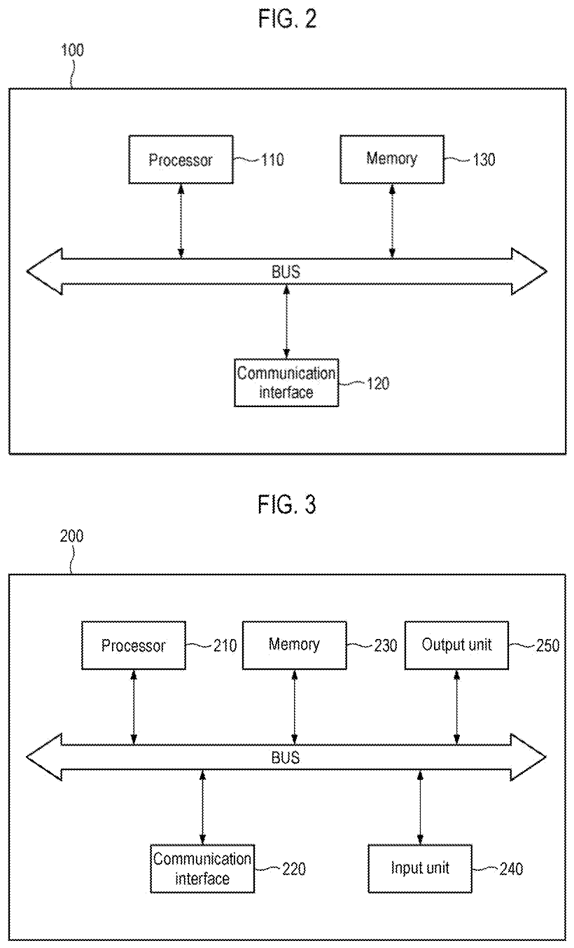

FIG. 2 is a block diagram of the server 100 according to embodiments of the present disclosure. The server 100 may include, as components, one or more processors 110, a communication interface 120, and a memory 130. In at least some embodiments, at least one of these components of the server 100 may be omitted, or other components may be added to the server 100. In at least some embodiments, additionally or alternatively, some components may be integrated, or may be implemented as a singular or a plurality of entities. At least some of the components inside or outside the server 100 may exchange data or signals with each other by being connected to each other through a bus, or through communication interfaces such as General Purpose Input/Output (GPIO), Serial Peripheral Interface (SPI), or Mobile Industry Processor Interface (MIPI).

One or more processors 110 may be referred to as a processor 110. The term “processor 110” may refer to a set of one or more processors, unless otherwise explicitly indicated in the context. The processor 110 may drive software (for example, instructions, programs, etc.) to control at least one component of the server 100 connected to the processor 110. In addition, the processor 110 may perform operations such as various calculations, processes, and data generation or processing. In addition, the processor 110 may load data or the like from the memory 130 or store them in the memory 130.

The communication interface 120 may perform wireless or wired communication between the server 100 and another device (for example, the user terminal 200 or another server). For example, the communication interface 120 may perform wireless communication according to various protocols or standards such as eMBB, URLLC, MMTC, LTE, LTE-A, NR, UMTS, GSM, CDMA, WCDMA, WiBro, WiFi, Bluetooth, NFC, GPS, or GNSS. In addition, for example, the communication interface 120 may perform wire communication according to various protocols or standards such as USB, HDMI, RS-232, or POTS.

The memory 130 may store various types of data. The data stored in the memory 130 may be data acquired, processed, or used by at least one component of the server 100, and may include software (for example, instructions, programs, etc.). The memory 130 may include a volatile or nonvolatile memory. The term “memory 130” may refer to a set of one or more memories, unless otherwise explicitly indicated in the context. The expression “a set of instructions stored in the memory 130” or “a program stored in the memory 130” referred to in the present disclosure may be used to refer to an operating system for controlling the resources of the server 100, an application, middleware that provides various functions to the application so that the application can utilize the resources of the server 100, etc. In embodiments, when the processor 110 performs a specific calculation, the memory 130 may store instructions that are executed by the processor 110 and correspond to the specific calculation.

In embodiments, the server 100 may transmit data according to a calculation result of the processor 110, data received by the communication interface 120, data stored in the memory 130, etc. to an external device. The external device may be a device for expressing, displaying, or outputting received data.

FIG. 3 is a block diagram of the user terminal 200 according to embodiments of the present disclosure. The user terminal 200 may include, as components, one or more processors 210, a communication interface 220, and a memory 230. In addition, the user terminal 200 may further include at least one of an input unit 240 and an output unit 250.

The processor 210 may drive software (for example, instructions, programs, etc.) to control at least one component of the user terminal 200 connected to the processor 210. In addition, the processor 210 may perform operations such as various calculations, processes, and data generation or processing. In addition, the processor 210 may load data or the like from the memory 230 or store them in the memory 230.

The communication interface 220 may perform wireless or wired communication between the user terminal 200 and another device (for example, the server 100 or another server). For example, the communication interface 220 may perform wireless communication according to various protocols or standards such as eMBB, URLLC, MMTC, LTE, LTE-A, NR, UMTS, GSM, CDMA, WCDMA, WiBro, WiFi, Bluetooth, NFC, GPS, or GNSS. In addition, for example, the communication interface 220 may perform wire communication according to various protocols or standards such as USB, HDMI, RS-232, or POTS.

The memory 230 may store various types of data. The data stored in the memory 230 may be data acquired, processed, or used by at least one component of the user terminal 200, and may include software (for example, instructions, programs, etc.). The memory 230 may include a volatile or nonvolatile memory. The term “memory 230” may refer to a set of one or more memories, unless otherwise explicitly indicated in the context. The expression “a set of instructions stored in the memory 230” or “a program stored in the memory 230” referred to in the present disclosure may be used to refer to an operating system for controlling the resources of the user terminal 200, an application, middleware that provides various functions to the application so that the application can utilize the resources of the user terminal 200, etc. In embodiments, when the processor 210 performs a specific calculation, the memory 230 may store instructions that are executed by the processor 210 and correspond to the specific calculation.

In embodiments, the user terminal 200 may further include the input unit 240. The input unit 240 may be a component that transmits data, which are received from the outside, to at least one component included in the user terminal 200. For example, the input unit 240 may include a mouse, a keyboard, a touch pad, and the like.

In embodiments, the user terminal 200 may further include the output unit 250. The output unit 250 may display, output, transmit, or send out information processed by the user terminal 200 to the outside. For example, the output unit 250 may visually display the information processed by the user terminal 200. The output unit 250 may display user interface (UI) information or graphic user interface (GUI) information. In this case, the output unit 250 may include at least one of a liquid crystal display (LCD), a thin film transistor-liquid crystal display (TFT-LCD), an organic light-emitting diode (OLED), a flexible display, a three-dimensional (3D) display, and an E-ink display. In addition, for example, the output unit 250 may audibly display the information processed by the user terminal 200. The output unit 250 may output audio data conforming to an arbitrary audio file format (for example, MP3, FLAC, WAV, etc.) through an audio device. In this case, the output unit 250 may include at least one of a speaker, a headset, and a headphone. In addition, for example, the output unit 250 may transmit the information processed by the user terminal 200 to an external output device. The output unit 250 may transmit or send out the information processed by the user terminal 200 to the external output device by using the communication interface 220. The output unit 250 may transmit or send out the information processed by the user terminal 200 to the external output device by using a separate output communication interface.

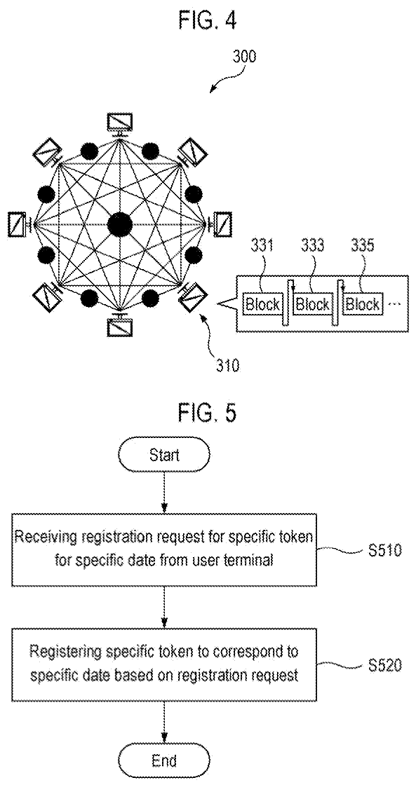

FIG. 4 is a conceptual diagram of the blockchain network 300 according to embodiments of the present disclosure. In the present disclosure, a block may refer to a specific data type. In addition, in the present disclosure, a blockchain may refer to a data structure in which one or more blocks, for example block 331, block 333, and block 335 are connected in a chain form. The one or more blocks 331, 333, and 335 included in the blockchain may be stored independently in one or more nodes included in the blockchain network 300, or may be distributed and stored across multiple nodes. Each of the one or more blocks 331, 333, and 335 may include a block hash, a block header, or a block body. The block hash is unique information that can identify a block, and may be, for example, a character string expressed in 256 bits. The block header may include at least one of, for example, version information of software or protocol, hash of the previous block according to the connection order of blocks on the blockchain, Merkle root, time information indicating when the block was created, bits representing difficulty of calculation, and Nonce which is a value which may be used for mining operations that add new blocks to the blockchain. The block body may include at least one transaction. A transaction is a set of data having a specific data structure, and may be a unit of information stored in the block body. The transaction may include information about the creation or transaction of a token. The transaction may be, for example, information indicating that “a first node included in the blockchain network 300 transmits a virtual currency token to a second node.” As another example, the transaction may be information indicating that “a first node included in the blockchain network 300 transmits a Non-Fungible Token (NFT) to a second node.”

The blockchain may be managed by the blockchain network 300 including at least one node. Each node included in the blockchain network 300 may be referred to as a “participant” of the blockchain network 300. The at least one node included in the blockchain network 300 may be operated by a hierarchical structure. The hierarchical structure may include at least one of, for example, a data layer that defines the structure of data handled by the blockchain network 300 and manages the data, a consensus layer that performs mining to verify the validity of a block and generate the block and is responsible for processing fees paid to a miner in the mining process, a common layer that implements or manages a P2P network protocol, a hash function, a digital signature, encoding, and a common repository, and an application layer where various applications are created or processed.

The at least one node included in the blockchain network 300 may share or store the transaction recorded on the blockchain. In addition, the at least one node included in the blockchain network 300 may perform a function of performing a verification operation on the transaction transmitted to the blockchain network 300 through a consensus algorithm of the blockchain and, when the verification is completed, recording the verified transaction in one block on the blockchain. The consensus algorithm performed by the blockchain network 300 may include at least one of a Proof of Work (PoW) algorithm, a Proof of Stake (PoS) algorithm, a Delegated Proof of Stage (DPoS) algorithm, a Practical Byzantine Fault Tolerance (PBFT) algorithm, a DBFT (Delegated Byzantine Fault Tolerance (DBFT) algorithm, an Redundant Byzantine Fault Tolerance (RBFT) algorithm, a Sieve algorithm, a Tendermint algorithm, a Paxos algorithm, a Raft algorithm, a Proof of Authority (PoA) algorithm, and a Proof of Elapsed Time (PoET) algorithm.

Each node included in the blockchain network 300 may store a smart contract. Through this, the nodes included in the blockchain network 300 can share the same smart contract. In addition, the smart contract may be recorded in one block on the blockchain managed by the blockchain network 300.

The smart contract is, for example, a document or script written in a programming language such as Solidity, and may be a program or application running on a virtual machine that is executed by at least one node included in the blockchain network 300. The smart contract may be written so that a specific action is executed when a specific condition is satisfied. In this case, the specific condition may be, for example, a condition in which a specific type of token is input or a specific type of file is input. In addition, the specific action may be, for example, an action such as transmitting a specific type of token to an arbitrary node of the blockchain network 300.

The smart contract may be written to comply with a certain rule (or protocol). For example, the smart contract may be written to include one or more functions corresponding to a protocol of each of Ethereum Request for Comment (ERC)-20 and ERC-721. However, by including other functions (for example, one or more functions corresponding to ERC-1155) not included in the exemplified protocols, in the smart contract, various types of smart contracts can be written.

The token referred to in the present disclosure may be or include a token that can be used on the blockchain managed by the blockchain network 300, and may be a virtual currency token (or a fungible token) or an NFT. The “non-fungible token” may refer to a virtual token created according to a smart contract written with reference to a certain protocol (for example, ERC-721, ERC-1155, etc.). This non-fungible token is recorded on the blockchain, which is a decentralized storage, thereby maintaining the integrity, and this non-fungible token can be created to include specific types of data, thereby guaranteeing the existence of specific types of data. Hereinafter, an object simply referred to as the “token” in the present disclosure may be an NFT, unless otherwise indicated in the context.

The token may be a set of data including specific types of data. In one specific embodiment, the token may include at least one of information for access to a digital file (for example, a specific image) associated with the token (hereinafter, also referred to as a “digital file Uniform Resource Identifier (URI)”), information for access to metadata of the token (hereinafter, also referred to as a “metadata URI”), and information about the current owner of the token (for example, an address on the blockchain of a node of the current owner of the token). In other embodiments, the token may further include a digital file associated with the token or metadata of the token. However, in the present disclosure, for convenience of description, it is assumed that the token includes a digital file URI or a metadata URI. In embodiments, “associated with” may mean, for example, connected with, corresponding to, etc.

The digital file URI associated with the token may be an address of a centralized server or a cloud server where a digital file is stored. In embodiments, the digital file URI may be a hash value (for example, “ipfs.io/ipfs/12345678”) of a digital file stored on an InterPlanetary File System (IPFS) that distributes and stores the file in multiple devices. The digital file accessed through the digital file URI may be, for example, an image file, a video file, or a music file. Hereinafter, in the present disclosure, the expression “digital file associated with the token” may refer to a digital file acquired through the digital file URI recorded in the token, and may be used interchangeably with an expression such as a “digital file possessed by a token.” A token according to the present disclosure may be associated with a specific object. The expression “a token is associated with a specific subject” may indicate a relationship between the token and the specific object when the digital file associated with the token is a digital file of the specific object (for example, an image or video of the specific object, or music composed by the specific object). The specific object may be, for example, a real person such as an entertainer or a celebrity, a virtual person such as a character, a group of such persons, or an animal such as a dog or a cat.

The metadata URI of the token may be an address of the centralized server or cloud server where metadata of the token are stored. In addition, it may be a hash value of metadata stored on IPFS. The metadata of the token may refer to a data set including various information about the token. The metadata may include at least one of, for example, token name, token identification information (hereinafter, also referred to as “token ID”), the name of a specific object associated with the token, the point of time when the token was created, information about the current owner of the token, history of change to the token owner, and information (for example the digital file URI described above) for access to the digital file associated with the token. In addition, in various embodiments, the metadata of the token may further include a date attribute group including at least one date attribute regarding the token, or token group information indicating one or more token groups to which the token belongs. When arbitrary metadata is expressed in a JavaScript Object Notation (JSON) format, the metadata may be expressed, for example, as {“Name”: “V”, “Image URI”: “https://ipfs.io/ipfs/12345678”, “Token ID”: “0xA024ED”, “Date Attributes Group”: [“Debut Date”: “2013-06-13”, “Second Album Release Date”: “2016-10-10”, “Concert Date”: “2021-11-27”], “Token Group Information”: “John”}. In the example related to the above-mentioned metadata, “Name” may be a key value indicating a token name, “Image URI” may be a key value indicating a digital file URI, “Token ID” may be a key value indicating a token identifier (ID), “Date Attributes Group” may be a key value indicating a date attribute group including at least one date attribute, and “Token Group Information” may be a key value indicating token group information of the relevant token. Hereinafter, in the present disclosure, the expression “first information included in the metadata of the token” may be expressed as “first information that the token has” or “first information included in the token” for convenience of description.

A token according to the present disclosure may belong to one or more token groups. The token group information corresponding to the token may include information (for example, a character string of a token group name) indicating each of one or more token groups to which the token belongs. For example, when a first token is a token created to correspond to person A, the token group information corresponding to the first token may include information indicating “person A token group.” In addition, when the first token is a token created to correspond to team B, the token group information corresponding to the first token may include information indicating “team B token group.” Further, when the first token is a token created to correspond to person C, and person C is a person belonging to team D including a plurality of persons, the first token may belong to a “person C token group” and at the same time a “team D token group.” In this case, the token group information corresponding to the first token may include information indicating “person C token group” and information indicating “team D token group.” The token group information corresponding to the token may be stored in the memory 130 of the server 100, recorded in one block on the blockchain, or included in the metadata of the token.

A token according to the present disclosure may be managed by a smart contract. In the present disclosure, the expression “a token is managed by a smart contract” may comprehensively refer to various operations in which, for example, a token is created by a smart contract, a token is transmitted from one user's address to another user's address, a token is incinerated, etc. The smart contract may contain various kinds of functions.

The smart contract may be created to comply with a certain rule (or protocol). For example, a smart contract written to comply with any first protocol (for example, ERC-20) may include a function that returns the total supply amount of virtual currency tokens. The smart contract written to comply with the first protocol may include a function that acquires an address on the blockchain of a specific node and returns the amount of virtual currency tokens held by the address. The smart contract written to comply with the first protocol may include a function that acquires an arbitrary amount of virtual currency tokens and an address on the blockchain of a node that receives the virtual currency token, and transmits the virtual currency tokens to the address of the receiving node. The smart contract written to comply with the first protocol may include a function that acquires an arbitrary amount of virtual currency tokens, an address on the blockchain of a node that sends the virtual currency token, and an address on the blockchain of a node that receives the virtual currency token, and transmits the virtual currency tokens from the address of the sending node to the address of the receiving node. The smart contract written to comply with the first protocol may include a function that returns whether withdrawal is allowed to limit the amount of withdrawable virtual currency tokens. In addition, the smart contract written to comply with the first protocol may include a function that returns the remaining amount that can be withdrawn.

In addition, a smart contract written to comply with an arbitrary second protocol (for example, ERC-721) may include a function that generates a token (for example, NFT) based on one or more pieces of information received from a specific node (hereinafter, also referred to as a “token generation function”). For example, the token generation function may acquire a URI of a specific digital file received from a specific node and an address on the blockchain of an arbitrary node, and generate a token corresponding to the URI of the corresponding digital file. When the token is generated by the token generation function, the owner information of the corresponding token may be determined according to the address on the blockchain of the arbitrary node input to the token generation function. The token generation function may further acquire one or more pieces of information (for example, a token name, a date attribute group including at least one date attribute regarding the token, etc.) to be included in the token metadata and generate the token. In the present disclosure, the expression “generating an NFT” may be used interchangeably with the expression “minting an NFT.” In addition, the smart contract written to comply with the second protocol may include a function that acquires an address on the blockchain of an arbitrary node and returns the amount of tokens held by the arbitrary address. The smart contract written to comply with the second protocol may include a function that acquires token ID of an arbitrary token and returns information about the owner who owns the token. The smart contract written to comply with the second protocol may include a function that acquires an address on the blockchain of an arbitrary node and token ID of the arbitrary token and grants the arbitrary node the authority to transmit a token with the corresponding token ID. The smart contract written to comply with the second protocol may include a function that acquires a token ID of an arbitrary token and returns an address on the blockchain of one or more nodes that have the authority to transmit the corresponding token.

The description of the smart contracts written to comply with the above-described first and second protocols is merely a description for explaining the functions included in the smart contract as examples, and does not limit the present disclosure. The smart contract according to the present disclosure may include various types of smart contracts including at least one function related to a token, for example at least one of the functions described above with respect to the above-described first and second protocols.

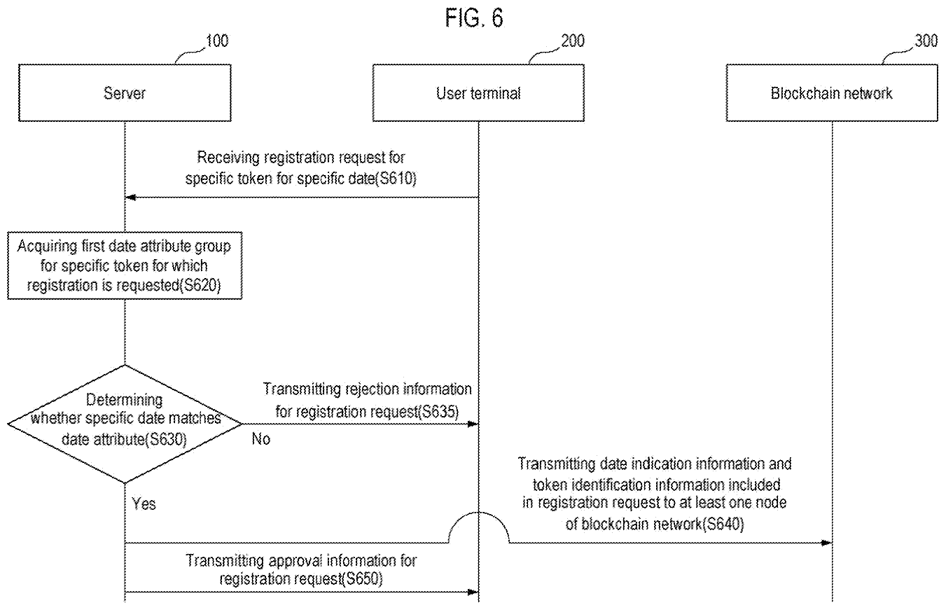

Hereinafter, an embodiment in which the server 100 receives a request for registration of a specific token for a specific date from the user terminal 200 will be described with reference to FIGS. 5 and 6.

FIG. 5 is a flowchart showing operations of the server 100 that processes a registration request for a specific token for a specific date received from the user terminal 200 according to embodiments of the present disclosure. The server 100 may receive a registration request for a specific token for a specific date from the user terminal 200, at operation S510. In the present disclosure, the “registration request for a specific token for a specific date” may include, for example, a Hyper Text Transfer Protocol (HTTP) request, and may include date indication information indicating a specific date and token identification information (for example, token ID) identifying a specific token. The specific date may be specified by date indication information included in the registration request as an arbitrary date including values of Year, Month, and Day. The date indication information may be a character string representing a date. For example, the registration request for a specific token for a specific date may include date indication information expressed as “2022-07-15” and token ID expressed in hexadecimal such as “0xA024ED.” In embodiments, the registration request for a specific token for a specific date may further include memo information. The memo information may include, for example, a character string having a specific length, such as “New album success wish!”. Hereinafter, for convenience of description, a specific date indicated by the date indication information included in the registration request for a specific token for a specific date may be referred to as a “desired registration date.” In addition, the point of time at which the server 100 receives the registration request transmitted from the user terminal 200 may be referred to as “registration request reception time.”

Next, the server 100 may register the specific token to correspond to the specific date based on the received registration request, at operation S520. In the present disclosure, the expression “a specific token is registered to correspond to a specific date” may mean that the server 100 corresponds a specific token with a specific date and generates information indicating that the specific token is registered to correspond to the specific date (hereinafter, also referred to as “token-date registration information”). That is, the date included in the registration request reception time and the desired registration date may be independent dates that are not related to each other. For example, when the registration request for the first token for Jan. 1, 2023 (which may be for example the desired registration date) arrives at the server 100 at 1:10:30 PM on Jul. 1, 2022, the server 100 can correspond the first token with Jan. 1, 2023, which is the desired registration date, immediately after receiving the registration request or within a certain period, and generate information indicating that the first token is registered to correspond to Jan. 1, 2023. Hereinafter, when the server 100 registers a specific token to correspond to a specific date based on the registration request, the specific date indicated by the date indication information included in the registration request may be referred to as a “registration date.” In addition, the expression “a token is registered to correspond to a specific date” may be used interchangeably with the expression such as “a token is registered on a specific date” for convenience of description.

The token-date registration information may include, for example, at least one of a registration date (or a desired registration date), a token ID of a token for which registration is requested, a registration request reception time, and memo information included in the registration request. For example, the token-date registration information may be expressed, for example, as {“registration date”: “2022-08-15”, “token ID”: “0x123456”, “registration request reception time”: “2022-07-01 18:30:00”, “memo”: “My favorite!”}. In addition, the token-date registration information may further include the point of time when registration is started. The registration start time may be set as the same time as the registration request reception time. The registration start time may be the point of time after the registration request reception time, and may be set as at least one of a time when a token is registered to correspond to a specific date, a time when the token-date registration information is generated, and a time when the token-date registration information is recorded in one block on the blockchain.

The token-date registration information may be recorded in an arbitrary storage space. The token-date registration information may be stored in the memory 130 of the server 100 or recorded on the blockchain. In at least some embodiments in which the token-date registration information is stored in the memory 130 of the server 100, the processor 110 may store the token-date registration information, which is generated based on the registration request, in the memory 130. For example, when the server 100 receives a registration request for registering a token A to correspond to Jan. 1, 2023, the processor 110 may store the token-date registration information including the token ID of the token A and the registration date (for example, Jan. 1, 2023) of the token A in the memory 130.

In at least some embodiments in which the token-date registration information is recorded on the blockchain, the processor 110 may transmit the token-date registration information, which is generated based on the registration request, to at least one node of the blockchain network 300. As a result, the fact that a specific token was registered on a specific date can be recorded in one block on the blockchain. For example, when the server 100 receives a registration request for registering the token A to correspond to Jan. 1, 2023, the processor 110 may generate the token-date registration information including the token ID of the token A and the registration date (for example, Jan. 1, 2023) of the token A, and transmit a transaction including the generated token-date registration information to at least one node of the blockchain network 300. The blockchain network 300 may verify the received transaction and, when the verification is completed, record the transaction including the token-date registration information in one block on the blockchain. As described above, the server 100 may register a specific token to correspond to a specific date based on the received registration request and request a record in at least one block on the blockchain, which may result in preventing forgery or falsification of whether the specific token is registered on the specific date.

In embodiments, the server 100 may receive a deregistration request for a specific token registered to correspond to a specific date from the user terminal 200. Based on the deregistration request, the server 100 may deregister the token registered to correspond to the specific date. The “deregistration request” may include token identification information identifying a specific token. In addition, the point of time when the server 100 receives the deregistration request transmitted from the user terminal 200 may be referred to as a “deregistration request reception time.”

In the present disclosure, the expression “a specific token registered to correspond to a specific date is deregistered” may mean that information indicating the deletion of the token-date registration information stored in the memory 130 of the server 100, or the deregistration of the specific date of the specific token (hereinafter, also referred to as “token-date deregistration information”) is recorded in one block on the blockchain managed by the blockchain network 300. For example, when the deregistration request for the first token for the specific date is received from the server 100 in a state where the token-date registration information is stored in the memory 130 of the server 100, the processor 110 may delete, from the memory 130, the token-date registration information indicating the fact that the first token is registered to correspond to the specific date.

In addition, when the deregistration request for the first token for the specific date is received from the server 100 in a state where the token-date registration information is recorded on the blockchain, the processor 110 may transmit the token-date deregistration information to at least one node of the blockchain network 300. The token-date deregistration information may include, for example, at least one of a token ID of a token for which deregistration is requested, a deregistration request reception time, and transaction information of the corresponding token-date registration information. In this case, the “transaction information of the corresponding token-date registration information” may refer to a unique ID of a transaction including the existing token-date registration information for a token for which deregistration is requested. For instance, the token-date deregistration information may be expressed, for example, as {“token ID”: “0x123456”, “deregistration request reception time”: “2022-07-02 15:30:00”, and “transaction information”: “0e3e2357e806b6cdb1f70b54c3a3a17b6714ee1f0e69bebb”}.

In various embodiments according to the present disclosure, a token may be locked-up for a specific period after being registered. In the present disclosure, the expression “a token is locked-up for a specific period after being registered” may mean that deregistration of the token, transfer of ownership of the token, incineration of the token, etc. are not possible from the time when token registration is started until the elapse of a specific period. Hereinafter, a token locked-up for a specific period after being registered may be referred to as a “token in lock-up state” for convenience.

The lock-up state of the token can be released when a specific condition is satisfied. In embodiments, the condition for releasing the lock-up state (hereinafter, also referred to as a “lock-up release condition”) may be a condition that is satisfied only when a specific period for releasing the lock-up has elapsed from the point of time when registration is started. Consider an example in which the specific period for releasing the lock-up is 3 months and the token-date registration information of the first token registered to correspond to a specific date is {“registration date”: “2022-08-15”, “token ID”: “0x123456”, “registration request reception time”: “2022-07-01 18:30:00”, “registration start time”: “2022-07-01 18:31:00”}. In this example, the first token is a token in the locked-up state until Oct. 1, 2022, 6:31:00 PM, which is 3 months from the point of time when registration is started (Jul. 1, 2022, 6:31:00 PM), and the release of the lock-up of the first token may not be possible during that time. That is, when the server 100 receives, from the user terminal 200, a deregistration request for the first token, a request for transferring the ownership of the first token, a request for incinerating the first token, etc. before 6:31:00 PM on Oct. 1, 2022, the processor 110 may reject the processing of the received request and transmit rejection information to the user terminal 200.

If data or information is stored and managed by a server using a centralized database according to a conventional database management scheme, a storage space burden on the server may be increased, or the data or information may even be leaked or damaged by hacking or attacking the server. Further, because a normal server is managed by a single subject, there is a possibility that such data or information may be changed by the subject, and thus the reliability of the information may be lowered. However, according to the present disclosure, when the server 100 manages the token using the blockchain technology, because token-related information is managed by the blockchain network 300, security may be enhanced, the storage space burden on the server 100 may be alleviated, and information reliability may be increased. As a result, improvements in database-related technology may be achieved.

FIG. 6 is a flowchart for explaining a method for the server 100 to process a registration request for a specific token for a specific date received from the user terminal 200 according to other embodiments of the present disclosure. When the server 100 receives a registration request for a specific token for a specific date, the server 100 may register a token according to whether or not the corresponding token can be registered on the corresponding date.

The server 100 may receive a registration request for a specific token for a specific date from the user terminal 200, at operation S610. Next, the processor 110 may acquire a first date attribute group for the specific token for which registration is requested, at operation S620. A token according to the present disclosure may be associated with a date attribute group including at least one date attribute. The “date attribute” associated with the token may be information indicating a date on which registration request can be made for the corresponding token. For example, the first date attribute group for a token A may include date attributes such as “2013-06-12,” “2013-09-11,” and “2014-02-12.” In this case, the token A can be registered for only one date among “2013-06-12,” “2013-09-11,” and “2014-02-12” included in the first date attribute group.

The date attribute group including at least one date attribute for the token may be recorded in any storage space. The date attribute group may be stored in the memory 130 of the server 100, or may be stored in metadata of the corresponding token. In at least some embodiments in which the date attribute group for the token is stored in the memory 130 of the server 100, the processor 110 may acquire the first date attribute group for a specific token from the memory 130. In other embodiments which the date attribute group for the token is included in the metadata of the token, the processor 110 may acquire the first date attribute group for a specific token for which registration is requested from at least one node of the blockchain network 300. For example, the processor 110 may transmit a request or transaction for function call to at least one node of the blockchain network 300 to inquire about the first date attribute group including at least one date attribute for the specific token and, as a result, may acquire the first date attribute group for the specific token.

Next, the processor 110 may determine whether or not a specific date (for example, a desired registration date) indicated by the date indication information included in the registration request matches one of date attributes included in the first date attribute group, at operation S630. If it is determined that the desired registration date does not match all of the date attributes included in the first date attribute group, the processor 110 may transmit rejection information for the registration request to the user terminal 200, at operation S635. For example, when the first date attribute group for the token A includes “2013-06-13”, “2016-10-10”, and “2021-11-27” and the desired registration date is “2021-01-01,” the processor 110 may determine through calculation that the desired registration date does not match any of the date attributes included in the first date attribute group, and may transmit rejection information for the registration request to the user terminal 200.

In the case where the token-date registration information is recorded on the blockchain, if it is determined that the desired registration date matches any one of the date attributes included in the first date attribute group, the processor 110 may transmit the date indication information and token identification information included in the registration request to at least one node of the blockchain network 300, at operation S640 Accordingly, the blockchain network 300 may record, in one block on the blockchain, information (for example, the token-date registration information) indicating that the token having the token identification information has been registered to correspond to a date indicated by the date indication information. The processor 110 may also transmit approval information for the registration request to the user terminal 200 prior to or subsequent to step S640, at operation S650. In addition, the processor 110 may also transmit approval information for the registration request to the user terminal 200 at the same time as step S640. For example, when the first date attribute group for the token A includes “2013-06-13,” “2016-10-10,” and “2021-11-27” and the desired registration date is “2021-11-27,” the processor 110 may determine through calculation that the desired registration date matches any one of the date attributes included in the first date attribute group, transmit the date indication information and token identification information included in the registration request to at least one node of the blockchain network 300, and transmit approval information for the registration request to the user terminal 200.

In at least some embodiments in which the token-date registration information is stored in the memory 130 of the server 100, if it is determined that the desired registration date matches any one of the date attributes included in the first date attribute group, the processor 110 may perform a step of generating information (for example the token-date registration information) indicating that the token having the token identification information has been registered to correspond to a date indicated by the date indication information, and storing the generated token-date registration information in the memory 130, instead of the above-described, at operation S640 Thereafter, the processor 110 may transmit approval information for the registration request to the user terminal 200.

The date attribute group for the token according to the present disclosure may be changed. Consider an example in which the specific object associated with the token is a singer A. In this case, when the singer A releases a new album, a date attribute indicating the release date of the new album may be added as a date attribute associated with the corresponding token. In addition, if the token for the singer A already includes the date attribute indicating the release date of the new album, but the release date of the new album is changed, the date attribute indicating the release date of the new album may be deleted or changed. Accordingly, various embodiments in which a date attribute group including at least one date attribute associated with a token is changed will be described below.

In at least some embodiments in which the date attribute group for the token is stored in the memory 130 of the server 100, the processor 110 may change the date attribute group stored in the memory 130. For example, when the first token and the first date attribute group including at least one date attribute are stored in the memory 130 to correspond with each other, the processor 110 may change the date attribute group so that the date attributes of the first date attribute group have different dates. In addition, the processor 110 may add a new date attribute to the first date attribute group or delete at least one date attribute of the first date attribute group.

In other embodiments in which the date attribute group for the token is included in the metadata of the token, the processor 110 may perform an operation for swapping an existing token with a new token. For example, when the first date attribute group includes at least one date attribute and the first token includes the first date attribute group, the processor 110 may generate a second date attribute group including a date attribute different from the at least one date attribute included in the first date attribute group. For example, the second date attribute group may include a date attribute different from the at least one date attribute included in the first date attribute group by additionally including a new date attribute for the first date attribute group or not including at least one date attribute included in the first date attribute group. The processor 110 may transmit a generation request for a second token to at least one node of the blockchain network 300. The generation request for the second token may include information about the first token (for example, the token ID of the first token), and the second date attribute group. The blockchain network 300 that received the generation request for the second token may acquire the metadata of the first token corresponding to the existing token based on the token ID of the first token included in the generation request for the second token, change the first date attribute group included in the metadata of the first token to the second date attribute group, and generate the second token based on the changed metadata. Through this, the second token, which is a new token, may be a token having the same information as the first token, which is an existing token, except that the second token may not include the first date attribute group, and instead may include the second date attribute which is a changed date attribute group.

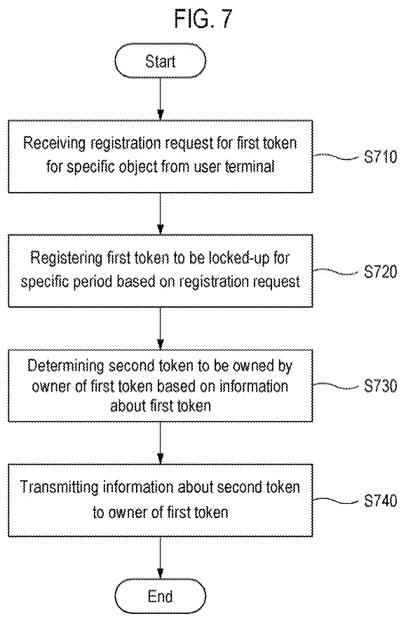

FIG. 7 is a flowchart showing operations of the server 100 that processes a registration request for a specific token associated with a specific object received from the user terminal 200 according to still further embodiments of the present disclosure. The server 100 may receive a registration request for the first token associated with a specific object from the user terminal 200, at operation S710. The first token for which registration is requested may be a token that has already been generated in association with the specific object. That is, a digital file of the first token associated with a person A may be an image or video obtained by photographing the person A. In embodiments, the “registration request for the first token associated with a specific object” may include, for example, token identification information (for example, a token ID) identifying the specific token. In other embodiments, the “registration request for the first token associated with a specific object” may further include date indication information indicating a specific date, similar to the above-described “registration request for a specific token on a specific date.”

Next, the server 100 may register the first token to be locked-up for a specific period based on the registration request received from the user terminal 200, at operation S720. The specific period for which the registered first token is locked-up may be, for example, 1 month, 3 months, 1 year, etc. For the first token locked-up for the specific period, at least one of deregistration, token ownership transfer, and token incineration may not be possible until the specific period has elapsed. In the present disclosure, the expression “a specific token is registered to be locked-up for a specific period” may mean that the server 100 generates information indicating that the specific token (for example the first token) is locked-up (hereinafter, also referred to as “token-lockup registration information”). For example, when the registration of the first token associated with the person A starts at 1:10:30 PM on Jul. 1, 2022 and the specific period for which the first token is locked-up is one year, the server 100 may generate information indicating that the first token is locked-up until 1:10:30 PM on Jul. 1, 2023, which is one year from the point of time when the registration of the first token is started. The token-lockup registration information may be recorded in any storage space, similar to the above-described token-date registration information. For example, the token-lockup registration information may be recorded on the memory 130 of the server 100 or on the blockchain.

Next, the server 100 may determine a second token to be owned by the owner of the first token based on the information about the first token registered to be locked-up, at operation S730. For example, when the information about the first token registered to be locked-up for a specific period satisfies a specific condition, the processor 110 may determine the second token to be owned by the owner of the first token. The second token may be, for example, a reward given to the owner of the first token as the specific condition is satisfied according to the lock-up of the first token. In embodiments, other types of rewards (for example, coupons, etc.) may be provided in place of the second token.

In embodiments, when the registered first token is a token associated with a specific object, the processor 110 may determine that a specific condition is satisfied and determine the second token to be owned by the owner of the first token. Consider an example in which the specific condition is satisfied when the registered first token is a token associated with the person A. Accordingly, if the first token registered to be locked-up for a specific period is a token associated with the person A, the processor 110 may determine that the specific condition is satisfied, and determine the second token to be owned by the owner of the first token.

In other embodiments, when the registered first token is a token registered to correspond to a specific date, the processor 110 may determine that a specific condition is satisfied, and determine the second token to be owned by the owner of the first token. Consider an example in which the specific condition is satisfied when the registered first token is a token registered to correspond to a specific date of Jan. 1, 2023. Accordingly, if the first token registered to be locked-up for a specific period is a token registered to correspond to Jan. 1, 2023, the processor 110 may determine that the specific condition is satisfied, and determine the second token to be owned by the owner of the first token.

In other embodiments, when the registered first token is a token that is associated with a specific object and is registered to correspond to a specific date, the processor 110 may determine that a specific condition is satisfied, and determine the second token to be owned by the owner of the first token. Consider an example in which the specific condition is satisfied when the registered first token is a token associated with the person A and registered to correspond to a specific date of Jan. 1, 2023. Accordingly, when the first token registered to be locked-up for a specific period is a token associated with the person A and registered to correspond to Jan. 1, 2023, the processor 110 may determine that the specific condition is satisfied, and determine the second token to be owned by the owner of the first token.

In other embodiments, when the token group information corresponding to the registered first token is specific token group information, the processor 110 may determine that a specific condition is satisfied, and determine the second token to be owned by the owner of the first token. Consider an example in which the specific condition is satisfied when the registered first token is a token belonging to the team B token group and the token group information includes information indicating the “team B token group.” Accordingly, if the token group information corresponding to the first token registered to be locked-up for a specific period includes the information indicating the “team B token group,” the processor 110 may determine that the specific condition is satisfied, and determine the second token to be owned by the owner of the first token.

In various embodiments according to the present disclosure, a specific object associated with the second token to be owned by the owner of the first token may be the same object as the specific object associated with the first token. That is, a digital file of the second token may be an image of the specific object associated with the first token. In embodiments, the second token may be a token registered in the blockchain network 300, as a pre-generated NFT. In this case, the processor 110 may modify the current owner information of the second token so that the owner of the first token owns the second token. For example, the processor 110 may transmit a request or transaction for function call to at least one node of the blockchain network 300 to change the owner information of the second token, and as a result, may change the owner information of the second token. In other embodiments, the processor 110 may generate the second token to be owned by the owner of the first token. For example, when information about the first token registered to be locked-up for a specific period satisfies a specific condition, the processor 110 may determine the second token to be owned by the owner of the first token by generating the second token to be owned by the owner of the first token. For example, the processor 110 may transmit a request or transaction for function call to at least one node of the blockchain network 300 to generate a new token (for example the second token) owned by the owner of the first token, and as a result, may generate the second token owned by the owner of the first token.

Next, the server 100 may transmit information about the second token to the owner of the first token, at operation S740. For example, the processor 110 may transmit the information about the second token to the user terminal of the owner of the registered first token, or may transmit the information about the second token to a node on the blockchain network 300 of the owner of the registered first token. The information about the second token may include, for example, token identification information of the second token, a digital file of the second token, etc.

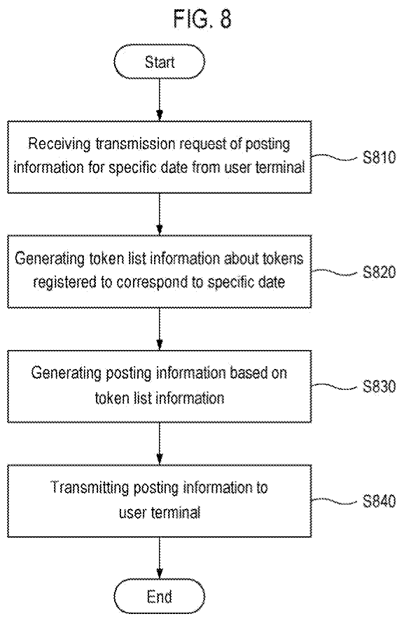

FIG. 8 is a flowchart showing operations of the server 100 that processes a transmission request of posting information received from the user terminal 200 according to embodiments of the present disclosure. The user terminal 200 may request the server 100 to transmit posting information for a specific date. In embodiments, when the posting information is associated with entries which are displayed in a calendar, the posting information may be referred to as calendar information.

The server 100 may receive the transmission request of the posting information for the specific date from the user terminal 200, at operation S810. In the present disclosure, the posting information may be information corresponding to the specific date, and it may be information that is generated based on a token registered to correspond to the specific date and is provided for displaying an area corresponding to the specific date on a calendar screen when a calendar is displayed in an arbitrary device. The transmission request requesting transmission of such posting information may include date indication information indicating the specific date. Hereinafter, in at least some embodiments, the specific date on which the transmission of the posting information is requested from the user terminal 200 may also be referred to as a “first date” for convenience of description.

Next, the server 100 may generate token list information about tokens registered to correspond to the specific date, at operation S820. The token list information according to the present disclosure may be information corresponding to the specific date on which the transmission of the posting information is requested, and it may be information having a specific data structure such as a list, an array, a set, etc. of token-related information.

The processor 110 may acquire information about at least one token registered to correspond to a specific date from the memory 130, or may acquire it from at least one node of the blockchain network 300. In at least some embodiments in which the above-described token-date registration information is stored in the memory 130 of the server 100, the processor 110 may acquire the information about at least one token registered to correspond to the specific date from the memory 130, and generate the token list information. In other embodiments in which the token-date registration information is recorded on the blockchain, the processor 110 may receive the information about at least one token registered to correspond to the specific date from at least one node of the blockchain network 300, and generate the token list information based on the received information about at least one token. The at least one node of the blockchain network 300 may include a smart contract including a function for inquiring about a token registered on a specific date. The function for inquiring about a token registered on a specific date may acquire a specific date and return the information about at least one token registered to correspond to the specific date. The processor 110 may transmit a function call request or transaction including a specific date included in the transmission request of the posting information to at least one node of the blockchain network 300 in order to call the function for inquiring about a token registered on the specific date. As a result, the processor 110 may receive the information about at least one token registered to correspond to the specific date from at least one node of the blockchain network 300, and generate the token list information accordingly.

The information about a token registered to correspond to the specific date acquired by the processor 110 from the memory 130 or the blockchain network 300 may be, for example, token ID, metadata URI, registration request reception time, memo information, etc. For example, when the information about the token registered to correspond to the specific date is expressed such as {“token ID”: X, “metadata URI”: Y, “registration request reception time”: Z}, the token list information may be expressed as an array including information about one or more tokens as an element, such as [{“token ID”: X1, “metadata URI”: Y1, “registration request reception time”: Z1}, {“token ID”: X2, “metadata URI”: Y2, “registration request reception time”: Z2}].

Next, the server 100 may generate the posting information based on the generated token list information, at operation S830. The posting information may include information about each of tokens registered to correspond to a specific date. The posting information about the specific date (for example the first date), for each of the tokens registered to correspond to the first date, may include at least one of an image associated with each token, the registration request reception time of each token, token group information corresponding to each token, and memo information of each token. In addition, the posting information may further include information indicating a posting priority associated with the tokens registered to correspond to the first date (hereinafter, also referred to as a “posting priority”).

The processor 110 may determine the posting priority based on the registration request reception time of each of the tokens registered to correspond to the first date. That is, when a plurality of tokens are registered for the first date, the processor 110 may compare the registration request reception times of the respective tokens to determine the posting priority in an order of registration request reception time. For example, the posting priority may be determined so that the tokens may have a higher priority based on having an earlier registration request reception time, however embodiments are not limited thereto. Consider an example in which information about each of the first token and the second token registered to correspond to the first date is included in the token list information, the registration request reception time of the first token is 12:00:00 PM on Jan. 1, 2022, and the registration request reception time of the second token is 12:00:01 PM on Jan. 1, 2022. In this case, because the registration request reception time of the first token for the first date is earlier than the registration request reception time of the second token for the first date, the processor 110 may determine the posting priority so that the first token has a higher priority than the second token.

The processor 110 may determine the posting priority based on the token group information corresponding to each token. In at least some embodiments in which the processor 110 determines the posting priority based on the token group information, the processor 110 determines the posting priority based on the number of tokens belonging to each of one or more token groups included in the token group information. For example, when 100 tokens belonging to the person A token group (for example, 100 tokens generated to correspond to the person A) are registered to correspond to the first date and 200 tokens belonging to the person B token group (for example, 200 tokens generated to correspond to the person B) are registered to correspond to the first date, because more tokens belonging to the person B token group than the tokens belonging to the person A token group are registered on the first date, the processor 110 may determine the posting priority so that the tokens belonging to the person B token group have a higher priority than the tokens belonging to the person A token group. In addition, as the number of tokens belonging to each of the one or more token groups is changed, the posting priority of tokens belonging to each token group may be changed. For example, when the number of tokens belonging to the person A token group registered to correspond to the first date increases from 100 to 150 and the number of tokens belonging to the person B token group registered to correspond to the first date decreases from 200 to 100, the processor 110 may determine the posting priority so that the tokens belonging to the person A token group have a higher priority than the tokens belonging to the person B group. In embodiments, the processor 110 may determine that tokens belonging to the same token group have the same posting priority.

In other embodiments in which the processor 110 determines the posting priority based on the token group information, the processor 110 may determine the posting priority based on the ratio of tokens registered on a specific date to all tokens issued to belong to each of one or more token groups included in the token group information. Consider an example in which the total number of tokens belonging to the person A token group is 200, among which 100 tokens are registered to correspond to the first date, and the total number of tokens belonging to the person B token group is 1,000, among which 200 tokens are registered to correspond to the first date. In this case, because the ratio of the tokens registered on the first date to all tokens issued to belong to the person A token group (for example, 100/200, 50%) is greater than the ratio of the tokens registered on the first date to all tokens issued to belong to the person B token group (for example, 200/1,000, 20%), the processor 110 may determine the posting priority so that tokens belonging to the person A token group have a higher priority than tokens belonging to the person B token group. In addition, as the ratio of tokens registered on a specific date to all tokens issued to belong to each of one or more token groups is changed, the posting priority of tokens belonging to each token group may be changed. For example, when the ratio of tokens registered on the first date to all tokens issued to belong to the person A token group is 50% and the ratio of tokens registered on the first date to all tokens issued to belong to the person B token group increases from 20% to 100%, the processor 110 may determine the posting priority so that the tokens belonging to the person B token group has a higher priority than the tokens belonging to the person A token group. In embodiments, the processor 110 may determine that tokens belonging to the same token group have the same posting priority.

In further embodiments in which the processor 110 determines the posting priority based on the token group information, the processor 110 may determine the posting priority based on the average registration request reception time of tokens (for example, the average value of the registration request reception times of tokens) belonging to each of one or more token groups included in the token group information. Consider an example in which the average registration request reception time of tokens registered to correspond to the first date and belonging to the person A token group is 1:30:00 PM on Jul. 11, 2022 and the average registration request reception time of tokens registered to correspond to the first date and belonging to the person B token group is 1:31:00 PM on Jul. 12, 2022. In this case, because the average registration request reception time of the tokens belonging to the person A token group is earlier than the average registration request reception time of the tokens belonging to the person B token group, the processor 110 may determine the posting priority so that the tokens belonging to the person A token group have a higher priority than the tokens belonging to the person B token group. In addition, as the average registration request reception time of tokens belonging to each of one or more token groups is changed, the posting priority of tokens belonging to each token group may be changed. Consider an example in which the registration request reception time of each of the first token, the second token, and the third token registered to correspond to the first date and belonging to the person A token group is sequentially 12:00:00 AM on Jul. 10, 2022, 12:00:00 AM on Jul. 14, 2022, and 12:00:00 AM on Jul. 15, 2022 (so that the average registration request reception time of tokens belonging to the person A token group registered to correspond to the first date is 12:00:00 AM on Jul. 13, 2022) and the registration request reception time of each of the fourth token, the fifth token, and the sixth token registered to correspond to the first date and belonging to the person B token group is sequentially 12:00:00 AM on Jul. 13, 2022, 12:00:00 AM on Jul. 14, 2022, and 12:00:00 AM on Jul. 15, 2022 (so that the average registration request reception time of tokens belonging to the person B token group registered to correspond to the first date is 12:00:00 AM on Jul. 14, 2022). According to this example, because the average registration request reception time of the tokens belonging to the person A token group is earlier than the average registration request reception time of the tokens belonging to the person B token group, the tokens belonging to the person A token group may have a higher priority than the tokens belonging to the person B token group. Accordingly, when the first token belonging to the person A token group is deregistered, the average registration request reception time of the tokens belonging to the person A token group may be changed to 12:00:00 PM on Jul. 14, 2022. As a result, because the average registration request reception time (12:00:00 AM on Jul. 14, 2022) of the tokens belonging to the person B token group is earlier than the average registration request time (12:00:00 PM on Jul. 14, 2022) of the tokens belonging to the person A token group, the processor 110 may determine the posting priority so that the tokens belonging to the person B token group have a higher priority than the tokens belonging to the person A token group. In embodiments, the processor 110 may determine that tokens belonging to the same token group have different posting priorities according to the registration request reception time of each token. Referring back to the above-described example, the fourth token, the fifth token, and the sixth token registered to correspond to the first date and belonging to the person B token group may have the posting priority according to the order of the registration request reception times of the tokens. That is, the fourth token may have the highest priority, the sixth token may have the lowest posting priority, and the fifth token may have the posting priority lower than the fourth token and higher than the sixth token.

The various embodiments related to the posting priority as described above are only exemplary descriptions for specifically explaining a method of determining the posting priority among tokens included in the posting information, and embodiments are not limited thereto.

The posting priority among tokens included in the posting information may be used when a calendar is displayed in an electronic apparatus such as the server 100 or the user terminal 200. Consider an example in which the user terminal 200 displays a calendar through the output unit 250 and the posting information for a specific date includes information about each of a plurality of tokens and the posting priority among the plurality of tokens. Accordingly, based on the posting priority included in the posting information, the user terminal 200 may determine whether to show an image associated with a particular token among the plurality of tokens at the top in one area for a specific date on a calendar screen, whether to show an image associated with a particular token first, whether to show an image associated with a particular token to be larger than other images associated with other tokens, whether to place an image associated with which token closer to the center of the screen than other images, etc.

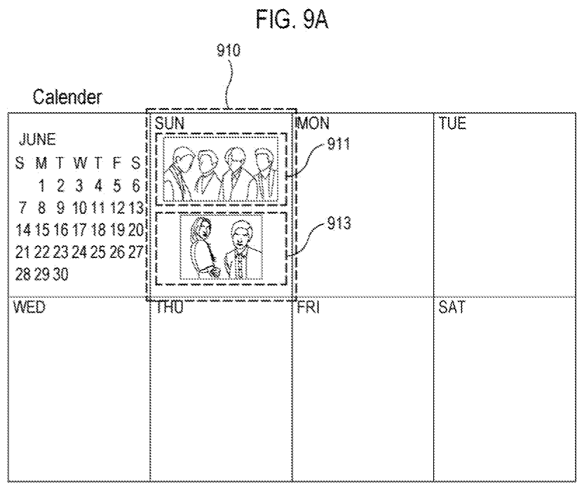

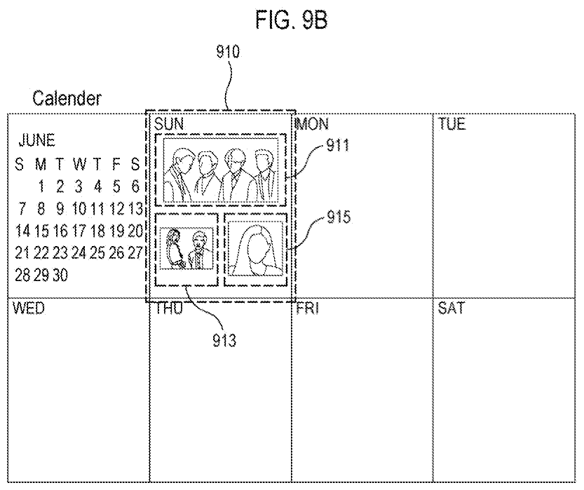

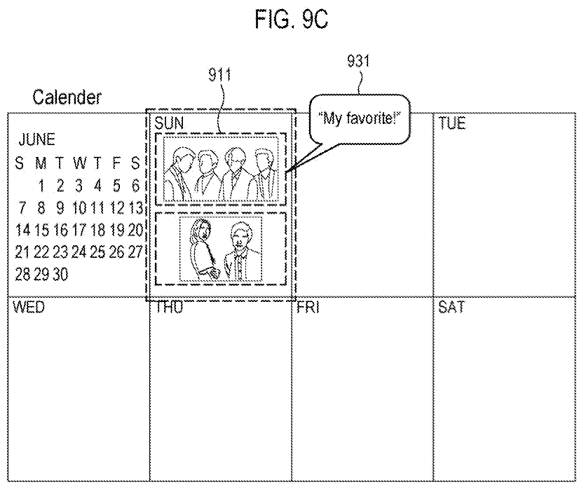

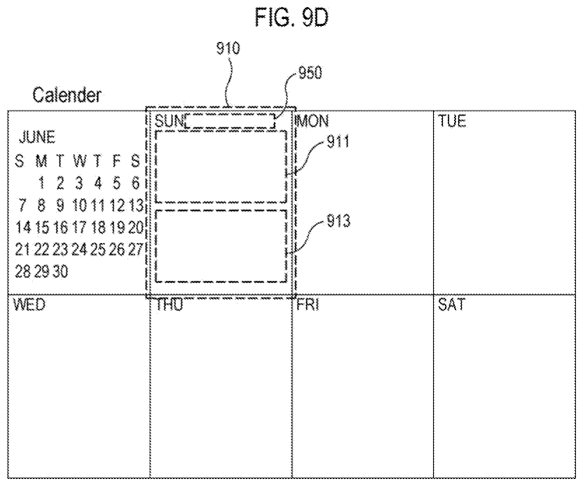

Next, the server 100 may transmit the posting information to the user terminal 200, at operation S840. The user terminal 200 may display the posting information in various ways through the output unit 250. For example, the processor 210 of the user terminal 200 may receive the posting information about a specific date from the server 100 and display the calendar screen through the output unit 250 based on the posting information. The calendar screen may include at least one area allocated to the specific date. For example, the processor 210 may determine information to be displayed in the area allocated to the specific date based on the posting information for the specific date. The area allocated to the specific date may include an area allocated to at least one token. The processor 210 may determine a display method or order of an area allocated to each token within the area allocated to the specific date, based on the posting priority included in the posting information. In embodiments, the posting information may be displayed through the output unit of the server 100 or the like. Hereinafter, a specific embodiment of a case in which the posting information is displayed through the output unit 250 of the user terminal 200 will be described with reference to FIGS. 9A to 9D.

FIG. 9A is an exemplary view showing a screen that can be displayed when the posting information is displayed through the output unit 250 of the user terminal 200 according to embodiments of the present disclosure. In embodiments, a token having a higher posting priority may be posted so as to be positioned at the top of the corresponding date on the screen of a calendar. In the example of FIG. 9A, the posting information for a specific date (for example the first date) includes information about the first token and information about the second token. Based on the posting information for the first date, the processor 210 may determine that an area 910 allocated to the first date includes an area 911 allocated to the first token and an area 913 allocated to the second token. Both the first token and the second token are tokens registered to correspond to the first date, and the processor 210 may determine a token having a higher posting priority among tokens included in the posting information as the first token, and a token having a lower posting priority as the second token. An image associated with the first token may be displayed in the area 911 allocated to the first token. An image associated with the second token may be displayed in the area 913 allocated to the second token. When the first token has a higher posting priority than the second token, the processor 210 may determine such that the area 911 allocated to the first token is located above the area 913 allocated to the second token within the area 910 for the first date, as shown in FIG. 9A. In embodiments, one or more of the first token, the second token, the image associated with the first token, the image associated with the second token, the area 911, and the area 913 may be referred to as an entry.

FIG. 9B is an exemplary view showing a screen that can be displayed when the posting information is displayed through the output unit 250 of the user terminal 200 according to other embodiments of the present disclosure. In embodiments, a token having a higher posting priority may be posted to occupy a wider size range on the screen of the calendar. In the example of FIG. 9B, the posting information for a specific date (for example the first date) includes information about the first token, information about the second token, and information about the third token. Based on the posting information for the first date, the processor 210 may determine such that an area 910 allocated to the first date includes an area 911 allocated to the first token, an area 913 allocated to the second token, and an area 915 allocated to the third token. All of the first token, the second token, and the third token are tokens registered to correspond to the first date, and the processor 210 may determine a token having the highest posting priority among the tokens included in the posting information, as the first token, a token having the lowest priority, as the third token, and a token having a posting priority lower than the first token and higher than the third token, as the second token. An image associated with the first token, an image associated with the second token, and an image associated with the third token may be displayed in the area 911 allocated to the first token, the area 913 allocated to the second token, and the area 915 allocated to the third token, respectively. When the first token has a higher posting priority than the other tokens (for example, the second token and the third token), the processor 210 may determine such that the area 911 allocated to the first token occupies a larger size range than the area 913 allocated to the second token and the area 915 allocated to the third token in the area 910 for the first date, as shown in FIG. 9B. In this case, the image displayed in the area 911 allocated to the first token may be displayed larger than the images displayed in the other areas. As shown in FIG. 9B, the area 913 allocated to the second token and the area 915 allocated to the third token occupy the same size range. However, embodiments are not limited thereto, and for example the area 913 allocated to the second token and the area 915 allocated to the third token may occupy different size ranges according to the posting priority of each token, in embodiments.

FIG. 9C is an exemplary view showing a screen that can be displayed when the posting information is displayed through the output unit 250 of the user terminal 200 according to still further embodiments of the present disclosure. The posting information for a specific date (for example the first date) received by the user terminal 200 from the server 100 may include memo information of a token registered to correspond to the first date. When the posting information includes memo information of a specific token, the processor 210 may display the memo information through the output unit 250. For example, when the posting information includes memo information of the first token registered to correspond to the first date, the processor 210 may display the memo information 931 of the first token in at least one area on the calendar screen. The memo information 931 of the first token may include, for example, a character string such as “My favorite!” In embodiments, the memo information 931 of the first token may be displayed as a result of the user touching or clicking the area 911 allocated to the first token. In other embodiments, the memo information 931 of the first token may be displayed at any location within the area allocated to the first token.

FIG. 9D is an exemplary view showing a screen that can be displayed when the posting information is displayed through the output unit 250 of the user terminal 200 according to still further embodiments of the present disclosure. A token according to the present disclosure may be a token (hereinafter, also referred to as an “advertisement token”) including information for accessing an advertisement image (for example, an advertisement image URI). The advertisement image URI associated with the advertisement token is a kind of the above-described digital file URI and may refer to an address of a centralized server or cloud server where the advertisement image is stored, or a hash value of the advertisement image stored on IPFS. Hereinafter, the description of overlapping matters will be omitted and the main differences of the advertisement token will be described.

The advertisement token may be a token generated by a specific function (hereinafter, also referred to as an “advertisement token generation function”) included in a smart contract executed by at least one node of the blockchain network 300. For example, the advertisement token generation function may be a function that acquires the advertisement image URI, one or more virtual currency tokens corresponding to a specific amount, and an address on the blockchain of the first node (for example, a node of a user who requests an advertisement), and generates a token having the URI of the advertisement image. The advertisement token generation function may be a function written to generate an advertisement token and then transmit the acquired one or more virtual currency tokens to an address on the blockchain of a second node (for example, a node of a server or a node of a user who provides an advertisement). The address on the blockchain of the second node may be included in a smart contract including the advertisement token generation function when the smart contract is written.

The server 100 may receive a registration request for an advertisement token for a specific date from the user terminal 200. The server 100 may register the advertisement token to correspond to the specific date (for example the first date) based on the received advertisement token registration request. In addition, when the server 100 receives a transmission request of the posting information for the first date from the user terminal 200 when the advertisement token is registered to correspond to the first date, the posting information transmitted by the server 100 to the user terminal 200 may include information about the advertisement token.

The posting information for the first date received by the user terminal 200 from the server 100 may include the information about the advertisement token registered to correspond to the first date. As an example, the processor 210 may display an image, which is associated with the advertisement token registered to correspond to the first date, in an advertisement area 950 included in the area 910 allocated to the first date. The advertisement area 950 may exist at any location within the area 910 allocated to the first date. As another example, the processor 210 may display the advertisement token in the area 910 allocated to the first date by treating the advertisement token similarly to tokens other than the advertisement token. For example, the posting information for the first date may include the information about the first token and the information about the second token, and at least one of the first token and the second token may be an advertisement token. In this case, when the first token is the advertisement token, the processor 210 may display an advertisement image, which is associated with the first token, in the area 911 allocated to the first token. In addition, when the second token is the advertisement token, the processor 210 may display an advertisement image, which is associated with the second token, in the area 913 allocated to the second token.

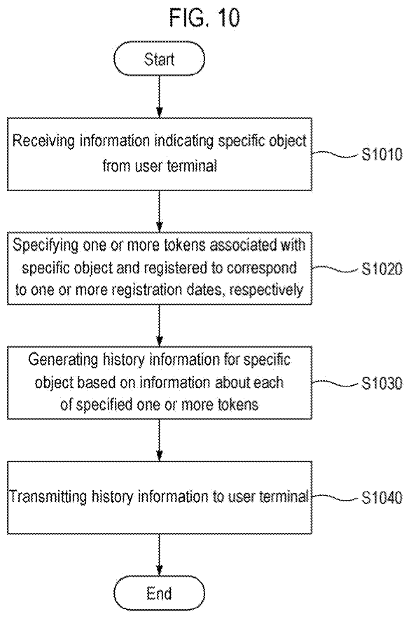

FIG. 10 is a flowchart showing operations of the server 100 that processes information indicating a specific object received from the user terminal 200 according to embodiments of the present disclosure. The server 100 according to the present disclosure may receive information indicating a specific object from the user terminal 200, generate history information for the specific object, and transmit the generated history information to the user terminal 200.

The server 100 may receive information indicating a specific object from the user terminal 200, at operation S1010. The information indicating the specific object may be, for example, the name of the specific object (for example, the name of a specific person) associated with a token. Next, the server 100 may identify, specify, or determine one or more tokens associated with the specific object and registered to correspond to one or more registration dates, respectively, at operation S1020. As described above, the “registration date” may refer to a specific date when the specific token is registered to correspond to a specific date based on a registration request. For example, “one or more tokens associated with a specific object and registered to correspond to one or more registration dates, respectively” may include a first token and a second token associated with the person A and registered to correspond to different dates, respectively. Hereinafter, the expression “one or more tokens associated with a specific object and registered to correspond to one or more registration dates, respectively” is used interchangeably with the expression “registration tokens associated with a specific object” for convenience of description. That is, the one or more registration tokens associated with a specific object may be one or more tokens registered to correspond to different registration dates, respectively.

In embodiments, the memory 130 of the server 100 may store information about one or more registration tokens associated with a specific object. In this case, the processor 110 may acquire information about one or more tokens associated with a specific object and registered to correspond to one or more registration dates, respectively, from the memory 130. For example, when a plurality of tokens registered to correspond to one or more registration dates, respectively, are stored in the memory 130 and tokens corresponding to the person A among the plurality of tokens are referred to as token a1, token a2, and token a3, respectively, the processor 110 may identify the token a1, the token a2, and the token a3 from the memory 130.

In other embodiments, the server 100 may identify one or more tokens by receiving information about one or more registration tokens associated with a specific object from the blockchain network 300. At least one node of the blockchain network 300 may include a smart contract including a function that returns information about one or more tokens associated with a specific object and registered to correspond to one or more registration dates, respectively (hereinafter, also referred to as a “registration token specific function associated with a specific object”). The “registration token specific function associated with a specific object” may acquire information indicating the specific object and return a token associated with the specific object among tokens registered to correspond to one or more registration dates. The processor 110 may transmit a function call request or transaction including information indicating a specific object to at least one node of the blockchain network 300 in order to call a function. For example, when the processor 110 transmits information indicating the person A to at least one node of the blockchain network 300, at least one node of the blockchain network 300 may execute the “registration token specific function associated with a specific object” to acquire information about one or more tokens (for example, referred to as token a1, token a2, and token a3) registered to correspond to one or more dates, as tokens corresponding to the person A, from at least one transaction recorded on the blockchain. As a result, the processor 110 may receive information about one or more tokens from at least one node of the blockchain network 300 and specify the token a1, the token a2, and the token a3 which are one or more tokens associated with the person A.

Next, the server 100 may generate history information for a specific object based on information about each of the specified one or more tokens, at operation S1030. The history information may include a registration date of a token and an image associated with the token. When the history information includes information about a plurality of tokens, the history information may include the order of tokens according to the registration date. For example, when the registration date of token a1 is Jun. 5, 2022, the registration date of token a2 is Jan. 19, 2020, and the registration date of token a3 is May 10, 2015, the processor 110 may generate history information including a plurality of images associated with the tokens to have the order of an image associated with the token a3, an image associated with the token a2, and an image associated with the token a1 according to the order of the registration date.

Next, the server 100 may transmit the generated history information to the user terminal 200, at operation S1040. Accordingly, the user terminal 200 may acquire history information about a specific object (for example, the person A) including an image of the specific object.

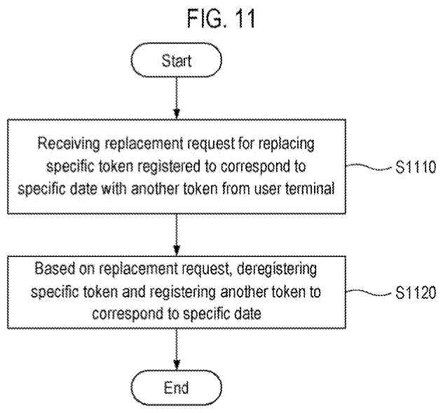

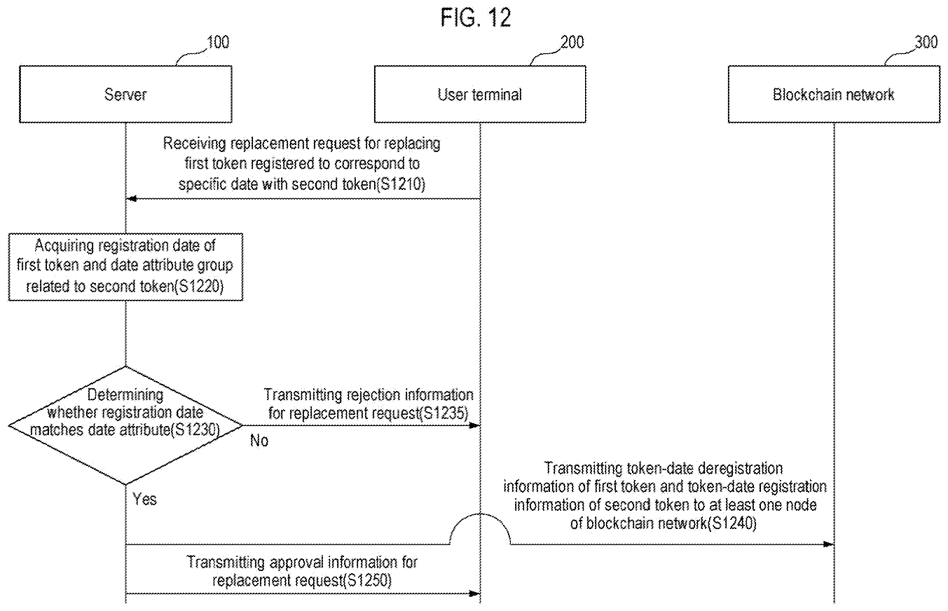

FIG. 11 is a flowchart showing operations of the server 100 that processes a replacement request received from the user terminal 200 according to embodiments of the present disclosure. In the present disclosure, the server 100 may replace a specific token registered to correspond to a specific date with another token. In at least some embodiments of the present disclosure described below with reference to FIGS. 11 and 12, for convenience of description, a specific token and another token may be referred to as a “first token” and a “second token,” respectively. When the first token registered to correspond to a specific date is replaced with the second token, the second token may be registered to correspond to the same specific date as the first token. In addition, when the first token registered to correspond to a specific date is replaced with the second token, the registration request reception time of the second token may be the same as the registration request reception time of the first token.

The server 100 may receive a replacement request for replacing the first token registered to correspond to the specific date with the second token from the user terminal 200, at operation S1110. The “replacement request” may include information about the first token and information about the second token. For example, the replacement request may include the token ID of the first token and the token ID of the second token. In addition, the point of time when the server 100 receives the replacement request transmitted from the user terminal 200 may be referred to as a “replacement request reception time.”

Next, based on the replacement request, the server 100 may deregister the first token and register the second token to correspond to the specific date, at operation S1120. In at least some embodiments in which information indicating that a specific token is registered to correspond to a specific date is stored in the memory 130 of the server 100, the processor 110 may acquire token-date registration information of the first token from the memory 130. The processor 110 may delete the token-date registration information of the first token from the memory 130 and generate token-date registration information of the second token. In this case, the processor 110 may generate the token-date registration information of the second token including the same registration date and registration request reception time as the token-date registration information of the first token. For example, when the token-date registration information of the first token is {“registration date”: “2023-01-01”, “token ID”: “0x1234”, “registration request reception time”: “2022-07-01 12:00:00”}, the generated token-date registration information of the second token may be {“registration date”: “2023-01-01”, “token ID”: “0x5678”, “registration request reception time”: “2022-07-01 12:00:00”}.

In other embodiments in which information indicating that a specific token is registered to correspond to a specific date is recorded in one block on the blockchain managed by the blockchain network 300, the processor 110 may transmit information about the first token included in the replacement request to at least one node of the blockchain network 300 and acquire the token-date registration information of the first token from the blockchain network 300. The processor 110 may generate the token-date registration information of the second token including the information about the second token included in the same registration date, registration request reception time, and replacement request as the token-date registration information of the first token. The processor 110 may deregister the first token for a specific date by transmitting the token-date deregistration information of the first token to at least one node of the blockchain network 300. The processor 110 may record the fact that the second token has been registered on a specific date, in one block on the blockchain, by transmitting the token-date registration information of the second token to at least one node of the blockchain network 300.

In embodiments, when replacing the first token with the second token, the server 100 may deregister the first token according to whether or not the lock-up release condition for the first token is satisfied. In at least some embodiments in which information indicating that a specific token is registered to correspond to a specific date is stored in the memory 130 of the server 100, the processor 110 may acquire the token-date registration information of the first token from the memory 130 and compare a first token registration start time included in the token-date registration information of the first token with a replacement request reception time. The processor 110 may determine whether or not the replacement request reception time has elapsed by a specific period (for example, 3 months) from the first token registration start time. If the replacement request reception time occurs after the specific period or more has elapsed from the first token registration start time, the processor 110 may determine that the lock-up release condition is satisfied. In embodiments, if the replacement request reception time occurs before the specific period or more has elapsed from the first token registration start time, the processor 110 may determine that the lock-up release condition is not satisfied. When the lock-up release condition is satisfied, the processor 110 may delete the token-date registration information of the first token from the memory 130 and perform an operation for replacing the first token with the second token, as described above. When the lock-up release condition is not satisfied, the processor 110 may transmit rejection information to the user terminal 200 in response to a replacement request.

In other embodiments in which information indicating that a specific token is registered to correspond to a specific date is recorded in one block on the blockchain managed by the blockchain network 300, the processor 110 may transmit information about the first token included in a replacement request to at least one node of the blockchain network 300 and acquire the token-date registration information of the first token from the blockchain network 300. The processor 110 may determine whether or not the lock-up release condition is satisfied, by comparing a first token registration start time included in the token-date registration information of the first token with a replacement request reception time. When the lock-up release condition is satisfied, the processor 110 may transmit the token-date deregistration information of the first token to at least one node of the blockchain network 300 and perform an operation for replacing the first token with the second token, as described above. When the lock-up release condition is not satisfied, the processor 110 may transmit rejection information to the user terminal 200 in response to a replacement request.

FIG. 12 is a flowchart for explaining a method of processing a replacement request of the user terminal 200 according to other embodiments of the present disclosure. The server 100 may receive a replacement request for replacing the first token registered to correspond to a specific date with the second token from the user terminal 200, at operation S1210. The replacement request may include information about the first token and information about the second token.

Next, the server 100 may acquire a registration date of the first token and a date attribute group related to the second token, at operation S1220. As described above, the date attribute group or token-date registration information including at least one date attribute related to a token may be recorded on the memory 130 or the blockchain. The processor 110 may acquire the token-date registration information of the first token including the registration date of the first token from the memory 130 or the blockchain network 300. The processor 110 may acquire the date attribute group related to the second token from the memory 130 or the blockchain network 300. For example, the token-date registration information of the first token may be expressed as {“registration date”: “2021-11-27”, “token ID”: “0x123456”, “registration request reception time”: “2021-07-01 18:30:00”}. In addition, the date attribute group related to the second token may be expressed as {“Date Attributes Group”: [“Debut Date”: “2013-06-13”, “Second Album Release Date”: “2016-10-10”, “Concert Date”: “2021-1-11-27”]}.

Next, the processor 110 may determine whether or not the registration date of the first token matches one of date attributes included in the date attribute group related to the second token, at operation S1230. If it is determined that the registration date of the first token does not match all of the date attributes included in the date attribute group related to the second token, the processor 110 may transmit rejection information for a replacement request to the user terminal 200, at operation S1235.

In the case where the token-date registration information is recorded on the blockchain, if it is determined that the registration date of the first token matches any one of date attributes included in the date attribute group related to the second token, the processor 110 may transmit the token-date deregistration information of the first token and the token-date registration information of the second token to at least one node of the blockchain network 300, at operation S1240. Referring back to the above-described example, because the registration date of the first token is Nov. 27, 2021 and the date attributes included in the date attribute group related to the second token are Jun. 13, 2013, Oct. 10, 2016, and Nov. 27, 2021 (which matches the registration date of the first token), the processor 110 may transmit the token-date deregistration information of the first token and the token-date registration information of the second token to at least one node of the blockchain network 300. The processor 110 may also transmit approval information for a replacement request to the user terminal 200 prior to or subsequent to step S1240, at operation S1250. In addition, the processor 110 may also transmit approval information for a replacement request to the user terminal 200 at the same time as step S1240.

In at least some embodiments in which the token-date registration information is stored in the memory 130 of the server 100, if it is determined that the registration date of the first token matches any one of date attributes included in the date attribute group related to the second token, the processor 110 may perform a step of deleting the token-date registration information of the first token from the memory 130, generating the token-date registration information of the second token, and storing the generated token-date registration information of the second token in the memory 130, instead of the above-described operation S1240. Thereafter, the processor 110 may transmit approval information for a replacement request to the user terminal 200.

In the sequence diagrams or flowcharts according to the present disclosure, steps of methods or algorithms are described in a sequential order, but the steps may be performed according to orders that may be arbitrarily combined, in addition to being performed sequentially. The sequence diagrams or flowcharts described herein do not exclude changes or modifications to the methods or algorithms and do not imply that any step is essential or desirable. In embodiments, at least some of the steps may be performed in parallel, iteratively, or heuristically. In embodiments, at least some of the steps may be omitted, or other steps may be added. In embodiments, one or more steps or operations of one or more methods or algorithms corresponding to one or more diagrams or flowcharts may be combined in any order.

Various embodiments according to the present disclosure may be implemented as software on a machine-readable storage medium. The software may be software for implementing various embodiments of the present disclosure. The software may be inferred from the various embodiments of the present disclosure by programmers in the art to which the present disclosure pertains. For example, the software may be a program that includes machine-readable instructions (for example, codes or code segments). The machine is a device capable of operating according to an instruction called from a storage medium, and may be, for example, a computer. In embodiments, the machine may be a computing device according to various embodiments of the present disclosure. In embodiments, a processor of the machine may execute a called instruction to cause components of the machine to perform a function corresponding to the instruction. In embodiments, the processor may be the processor 110 and 210 according to the embodiments of the present disclosure. The storage medium may refer to any type of recording medium that can be read by the machine and in which data are stored. Examples of the storage medium may include ROM, RAM, CD-ROM, magnetic tape, floppy disk, optical data storage device, and the like. In embodiments, the storage medium may be the memory 130 and 230. In embodiments, the storage medium may be implemented as a distributed form in a computer system or the like connected to a network. The software may be distributed, stored, and executed in a computer system or the like. The storage medium may be a non-transitory storage medium. The non-transitory storage medium may refer to a tangible medium that exists regardless of whether data are stored semi-permanently or temporarily, and does not include signals that are propagated transitorily.

Although the technical ideas according to the present disclosure have been described with the above various embodiments, the technical ideas according to the present disclosure include various substitutions, modifications, and alterations that can be made within a range that can be understood by a person having ordinary knowledge in the art to which the present disclosure pertains. It is also to be understood that such substitutions, modifications, and alterations may fall within the scope of the appended claims.

According to the present disclosure in at least embodiments, it is possible to prevent a user who purchases a token that can be registered to correspond to one specific date from registering the token on a plurality of specific dates.

According to the present disclosure in at least embodiments, it is possible to prevent one area for a specific date on a calendar screen displayed in a user terminal from being excessively filled with a specific object corresponding to a token.

According to the present disclosure in at least embodiments, it is possible to easily understand history information about a specific object.

According to the present disclosure in at least embodiments, it is possible for a user who has registered a token to correspond to a specific date to arbitrarily change the registered token to another token.

While the foregoing methods have been described with respect to particular embodiments, these methods may also be implemented as computer-readable code on a computer-readable recording medium. The computer-readable recording medium includes any kind of data storage devices that can be read by a computer system. Examples of the computer-readable recording medium includes ROM, RAM, CD-ROM, magnetic tape, floppy disk, optical data storage device and the like. Also, the computer-readable recording medium can be distributed to computer systems which are connected through a network so that the computer-readable code can be stored and executed in a distribution manner. Further, the functional programs, code, and code segments for implementing the foregoing embodiments can easily be inferred by programmers in the art to which the present disclosure pertains.

While certain embodiments have been described, these embodiments have been presented by way of example only, and are not intended to limit the scope of the disclosures. Indeed, the embodiments described herein may be embodied in a variety of other forms. Furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. An electronic apparatus comprising:
a communication interface configured to communicate with one or more nodes of a blockchain network and an external device;
one or more memories configured to store one or more instructions; and
one or more processors configured to execute the one or more instructions to:
receive a registration request for a token for a date from the external device; and
register the token to correspond to the date based on the registration request, and
transmit posting information associated with the date to the external device, wherein the posting information includes a display attribute of an entry corresponding to the token,
wherein the registration request includes date indication information indicating the date, and token identification information identifying the token, and
wherein the display attribute is determined based on the date indication information, and includes at least one from among a display priority of the entry, a display position of the entry, and a display size of the entry.

2. The electronic apparatus of claim 1, wherein the one or more processors are further configured to register the token with the blockchain network by transmitting the date indication information and the token identification information to the one or more nodes of the blockchain network.

3. The electronic apparatus of claim 2, wherein the token includes a first date attribute group including one or more date attributes, and
wherein the one or more processors are further configured to:
acquire the first date attribute group from the one or more nodes of the blockchain network;
determine whether the date indicated by the date indication information matches a date attribute of the one or more date attributes; and
transmit the date indication information and the token identification information to the one or more nodes of the blockchain network according to a determination that the date matches the date attribute of the one or more date attributes.

4. The electronic apparatus of claim 2, wherein the one or more memories are further configured to store a first date attribute group including one or more date attributes corresponding to the token, and
wherein the one or more processors are further configured to:
acquire the first date attribute group from the one or more memories;
determine whether the date indicated by the date indication information matches a date attribute of the one or more date attributes; and
transmit the date indication information and the token identification information to the one or more nodes of the blockchain network according to a determination that the date matches the date attribute of the one or more date attributes.

5. The electronic apparatus of claim 1, wherein the one or more processors are further configured to:
receive a replacement request for replacing the token registered to correspond to the date with a replacement token from the external device; and
based on the replacement request, deregister the token and register the replacement token to correspond to the date, and
wherein the replacement request includes information about the token and information about the replacement token.

6. The electronic apparatus of claim 5, wherein the one or more processors are further configured to deregister the token based on a lock-up release condition for the token being satisfied, and
wherein the lock-up release condition is satisfied based on a predetermined period elapsing from a start of a registration time of the token.

7. The electronic apparatus of claim 1, wherein the token includes information for accessing an image.

8. The electronic apparatus of claim 1, wherein the one or more processors are further configured to:
receive a transmission request for the posting information about the date from the external device;
generate token list information about a plurality of tokens registered to correspond to the date;
generate the posting information based on the token list information; and
transmit the posting information to the external device, and
wherein the posting information includes information about each token of the plurality of tokens.

9. The electronic apparatus of claim 8, wherein the one or more processors are further configured to:
receive information about one or more tokens from among the plurality of tokens registered to correspond to the date from the one or more nodes of the blockchain network; and
generate the token list information based on the information about the one or more tokens.

10. The electronic apparatus of claim 8, wherein the posting information includes a posting priority corresponding to the plurality of tokens, and
wherein the one or more processors are further configured to determine the posting priority based on a registration request reception time of the each token of the plurality of tokens.

11. The electronic apparatus of claim 8, wherein the token list information includes token group information indicating one or more token groups to which the plurality of tokens respectively belong,
wherein the posting information includes a posting priority corresponding to the plurality of tokens, and
wherein the one or more processors are further configured to determine the posting priority based on the token group information.

12. The electronic apparatus of claim 11, wherein the one or more processors are further configured to determine the posting priority based on a number of tokens belonging to each token group of the one or more token groups.

13. The electronic apparatus of claim 8, wherein the token comprises a first token including a first date attribute group including at least one first date attribute,
wherein the one or more processors are further configured to:
generate a second date attribute group including at least one second date attribute, wherein the at least one second date attribute is different from the at least one first date attribute; and
transmit a generation request for a second token to the one or more nodes of the blockchain network, and
wherein the generation request for the second token includes information about the first token and information about the second date attribute group.

14. The electronic apparatus of claim 8, wherein the one or more processors are further configured to:
receive information indicating an object from the external device;
identify one or more tokens which are associated with the object and registered to correspond to one or more registration dates;
generate history information for the object based on information about each of the identified one or more tokens; and
transmit the history information to the external device.

15. A method performed by an electronic apparatus including one or more processors, the method comprising:
receiving a registration request for a token for a date from an external device; and
registering the token to correspond to the date based on the registration request; and
transmitting posting information associated with the date to the external device, wherein the posting information includes a display attribute of an entry corresponding to the token,
wherein the registration request includes date indication information indicating the date and token identification information identifying the token, and
wherein the display attribute is determined based on the date indication information, and includes at least one from among a display priority of the entry, a display position of the entry, and a display size of the entry.

16. The method of claim 15, wherein the registering of the token further includes transmitting the date indication information and the token identification information to one or more nodes of a blockchain network.

17. The method of claim 15, further comprising:
receiving a transmission request for posting information for the date from the external device;
generating token list information about a plurality of tokens registered to correspond to the date;
generating the posting information based on the token list information; and
transmitting the posting information to the external device,
wherein the posting information includes information about each token of the plurality of tokens.

18. A method performed by an electronic apparatus including one or more processors, the method comprising:
transmitting a registration request for a token for a date to an external device; and
receiving approval information corresponding to the registration request from the external device based on the registration request and information stored in one or more nodes of a blockchain network;
receiving posting information associated with the date from the external device, wherein the posting information includes a display attribute of an entry corresponding to the token; and
displaying the entry on a display of the electronic apparatus according to the display attribute,
wherein the registration request includes date indication information indicating the date and token identification information identifying the token, and
wherein the display attribute is determined based on the date indication information, and includes at least one from among a display priority of the entry, a display position of the entry, and a display size of the entry.

19. The method of claim 18, further comprising:
transmitting a transmission request for posting information for the date to the external device; and
receiving the posting information from the external device based on the transmission request,
wherein the posting information is generated based on token list information about a plurality of tokens registered to correspond to the date, and includes information about each token of the plurality of tokens.

20. An electronic apparatus comprising:
a communication interface configured to communicate with one or more nodes of a blockchain network and an external device;
one or more memories configured to store one or more instructions; and
one or more processors configured to execute the instructions to:
receive a registration request for a first token associated with an object from the external device;
register the first token to be locked-up for a period of time based on the registration request;
determine a second token to be owned by an owner of the first token based on information about the first token; and
transmit information about the second token to the owner of the first token.
